(19) United States
(12) Patent Application Publication
(10) Pub. No.: US 2026/0288795 A1
(43) Pub. Date: Sep. 24, 2026

(54) SYSTEM

(71) Applicant: SoftBank Group Corp., Tokyo (JP)

(72) Inventor: Yutaro YAMANAKA, Tokyo (JP)

(73) Assignee: SoftBank Group Corp., Tokyo (JP)

(21) Appl. No.: 19/555,939

(22) Filed: Mar. 4, 2026

(30) Foreign Application Priority Data
Mar. 19, 2025 (JP) 2025-044490

(51) Int. Cl. G06F 16/3329; G06F 40/284

(52) U.S. Cl. CPC G06F 16/33295; G06F 40/284

(57) ABSTRACT

A system includes a processor that is configured to provide an interface for inputting user experience information and future goal information, analyze input information and generate a prompt for instructing a generative AI model to execute a specified processing operation, and transmit the generated prompt to the generative AI model and receive a response from the generative AI model.

### CROSS-REFERENCE TO RELATED APPLICATION

This application is based on and claims priority under 35 USC 119 from Japanese Patent Application No. 2025-044490 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional career support systems and personnel development tools are often limited to static questionnaires, rule-based matching engines, or predefined recommendation logic. Such systems generally cannot flexibly interpret free-form user input describing individual experience and future goals, and therefore fail to generate highly tailored advice or information. Additionally, even when generative AI models are available, there is no integrated mechanism for automatically converting user input into effective prompts that cause the generative AI models to perform suitable processing. As a result, users must manually design prompts and interact with generative AI systems without guidance, which requires specialized knowledge and leads to inconsistent output quality. Moreover, the responses generated by generative AI models are often presented as raw text without being clearly contextualized or visualized in relation to the user's career development, making it difficult for users to understand and utilize the information effectively. Accordingly, there is a need for a system that can accept user experience and future goal information, automatically generate appropriate prompts for a generative AI model by analyzing the input, and present the resulting responses in a form that directly supports the user's career development.

### SUMMARY

In order to solve the above-described problems, the invention provides a system comprising a processor, wherein the processor is configured to provide an interface for inputting user experience information and future goal information, analyze input information and generate a prompt for instructing a generative AI model to execute a specified processing operation, and transmit the generated prompt to the generative AI model and receive a response from the generative AI model. The processor is further configured to analyze user input data by using natural language processing techniques and create a prompt for instructing the generative AI model to execute an optimal processing operation, thereby automatically transforming free-form user input into an effective prompt without requiring specialized prompt engineering knowledge from the user. Additionally, the processor is configured to visually display the response from the generative AI model as information related to career development of the user, for example by structuring, highlighting, or otherwise presenting the response in a manner that clarifies how the suggested actions, skills, or learning paths correspond to the user's current experience and future goals. Through these configurations, the system enables accurate interpretation of user input, efficient utilization of generative AI capabilities, and user-friendly visualization of AI-generated results, thereby supporting the user's career formation in a more effective and individualized manner.

The term “system” refers to an arrangement of hardware and/or software components that cooperate to perform the processing operations described in the claims, including at least one processor and any associated memory, interfaces, and programs.

The term “processor” refers to one or more hardware processing units, such as a central processing unit (CPU), a graphics processing unit (GPU), a microcontroller, or any combination thereof, that executes instructions to implement the functions described in the claims.

The term “interface” refers to a hardware and/or software component that enables a user to input information into the system and receive information from the system, including but not limited to graphical user interfaces, web interfaces, mobile application interfaces, and command-line interfaces.

The term “user experience information” refers to information describing the past or current professional activities, skills, roles, achievements, or work history of a user, as input through the interface.

The term “future goal information” refers to information describing a user's desired future career direction, target roles, skills to be acquired, or professional objectives, as input through the interface.

The term “input information” refers to any information, including user experience information and future goal information, that is received by the system through the interface and processed by the processor.

The term “prompt” refers to a text or structured instruction generated by the processor and provided to a generative AI model, specifying a task, a processing operation, or a request for generating content, analysis, or recommendations.

The term “generative AI model” refers to a machine learning model that is capable of generating text, images, or other content in response to a prompt, including but not limited to large language models and other neural network-based generative models.

The term “specified processing operation” refers to any processing that the generative AI model is requested to perform in response to the prompt, such as generating advice, analyzing career options, proposing learning plans, or creating other content related to the user's input.

The term “optimal processing operation” refers to a processing operation selected or formulated by the processor, based on analysis of user input data, so as to be most suitable for addressing the user's experience information and future goal information in view of the capabilities of the generative AI model.

The term “user input data” refers to data entered by the user via the interface, including but not limited to free-form text describing experience, goals, questions, constraints, or preferences.

The term “natural language processing techniques” refers to algorithms and methods for analyzing, interpreting, and transforming human language text, including but not limited to tokenization, part-of-speech tagging, parsing, semantic analysis, entity recognition, keyword extraction, embeddings, and intent detection.

The term “response” refers to information output by the generative AI model in reaction to a prompt, such as generated text, structured recommendations, lists of skills, learning plans, or other generated content.

The term “visually display” refers to presenting information on a display device or graphical user interface in a human-perceptible visual form, such as text, charts, tables, diagrams, or highlighted sections.

The term “information related to career development of the user” refers to information that assists the user in planning, improving, or advancing a career, including suggestions of skills to acquire, recommended roles, learning paths, project ideas, networking advice, or other guidance associated with the user's professional growth.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

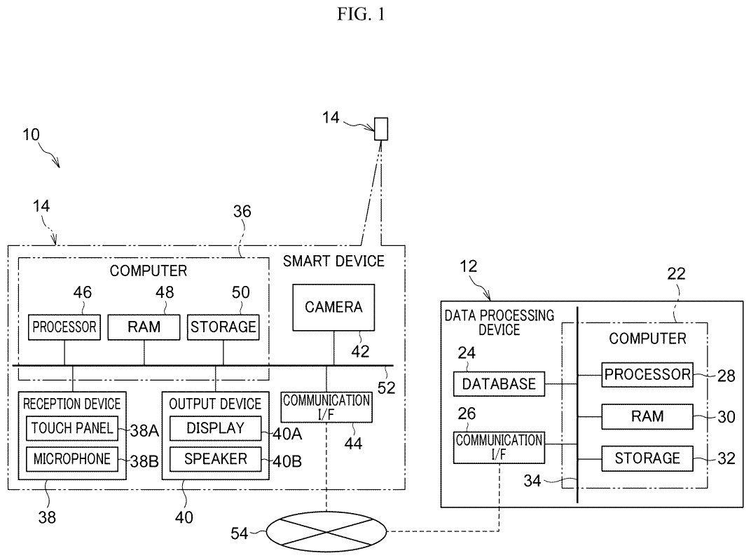

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

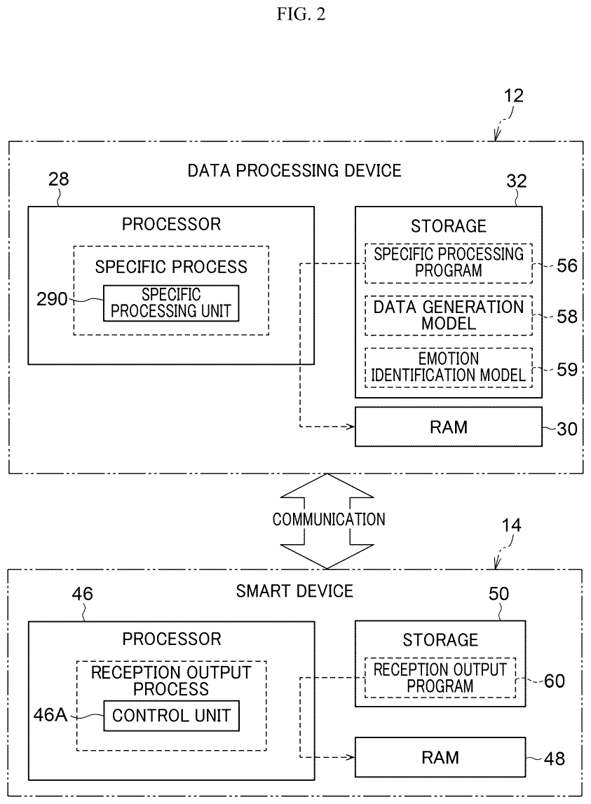

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented career support systems generally collect free-text input from users and display static, rule-based guidance. Such systems typically rely on manually authored decision trees or fixed templates, and therefore are limited in their ability to process diverse natural language descriptions of user experience and goals. As a result, these systems frequently generate advice that is generic, poorly aligned with a user's actual background, and difficult to adapt to rapidly changing skill requirements and job categories. Recent advances in generative AI models allow generation of rich, personalized textual advice. However, simply connecting a user interface to a generative AI model via an application programming interface does not necessarily improve core computer functionality. In many conventional integrations, user text is passed directly to the model as-is, without systematic analysis, classification, or structuring by the intermediary system. This leads to several technical problems: the generated responses may be unstructured or excessively long, the content may omit critical elements such as concrete skills and learning sequences, and the responses may contain inappropriate or unusable segments. The computing resources of both client and server are then wasted on transmitting, rendering, and storing low-quality responses that are not tailored to the user's actual state.

Furthermore, existing systems often do not maintain an explicit association between a particular, structured prompt sent to the generative AI model and the corresponding response. Without such an association and without a normalized advice information structure, it is difficult for the system to perform efficient post-processing, filtering, re-use, or comparison of advice across multiple user sessions. This limits the ability of the system to systematically improve the relevance and consistency of generated output and to optimize the use of network bandwidth, processor time, and memory resources.

In addition, many conventional systems rely heavily on the client device to handle presentation logic, resulting in duplicated or inconsistent implementations of content structuring and safety filtering across different client platforms. This fragmentation can lead to increased processing on resource-constrained terminals, redundant data transfers, and inconsistent user experiences. There is a need for a server-centric mechanism that programmatically transforms unstructured user input into a well-defined prompt sentence adapted to a generative AI model, receives a response, normalizes and filters the response into a structured advice representation, and then provides terminals with display-ready, segmented data.

Accordingly, there is a need for an improved computer-implemented technique that (i) systematically analyzes and classifies user free-text input into feature information, (ii) generates optimized prompt sentences instructing a generative AI model regarding processing policy and response structure, (iii) post-processes the generated response into a normalized advice information structure with explicit constituent elements, and (iv) controls the generation and display of visual output information on terminals based on this structured representation. Such a technique should improve the technical functioning of the overall system by reducing unnecessary data transmission, offloading complex text structuring and filtering to a centralized server, and enabling more efficient execution of natural language processing and generative inference workflows.

The specific processing by the specific processing unit 290 of the data processing device 12 in Example 1 is realized by the following means.

The present invention provides a server comprising a processor and a memory storing instructions that, when executed by the processor, cause the processor to control a user interface to receive character information representing a user's experience and future goals, convert the character information into a communication data format, validate and transmit the communication data format to an information processing apparatus, analyze the character information using a natural language processing algorithm to extract feature information including at least a job content, a skill, a desired field, and a target time, generate, based on the feature information and the character information, a prompt sentence that specifies processing content and an output format to be executed by a generative AI model, construct the prompt sentence together with authentication information and processing conditions as a communication request to an external generative AI model providing apparatus, receive response data including response character information generated by the generative AI model based on the prompt sentence, analyze the response character information to extract constituent elements including at least a skill name, a learning item, a learning order, a recommended job, and an action candidate, reconstruct the constituent elements as an advice information structure and store the advice information structure in association with the prompt sentence, and generate, based on the advice information structure, visual output information including at least an advice display area in which a list of skills, a learning plan, recommended jobs, and action candidates regarding career development of the user are divided and displayed, and control display of the visual output information on a terminal. This enables the computer system to transform unstructured user input into optimized prompt sentences for a generative AI model, to normalize and filter the model's responses into a structured advice representation, and to deliver display-ready, segmented guidance to terminals, thereby improving the efficiency, reliability, and technical functionality of natural language-based career support processing.

The term “user” refers to a human operator who provides experience and future goal information to the system via a user interface on a terminal.

The term “terminal” refers to an electronic device including at least a display unit, an input unit, a communication unit, and a processor, and configured to present a user interface, receive user input, and communicate with a server.

The term “server” refers to an information processing apparatus including at least one processor, a memory, and a communication interface, and configured to execute backend processing including analysis of user information, generation of prompt sentences, communication with a generative AI model, and generation of advice information.

The term “processor” refers to a hardware computational unit, such as a central processing unit or an equivalent processing circuit, that executes instructions stored in a memory to perform data processing and control operations of the system.

The term “memory” refers to a hardware storage resource, such as a volatile or non-volatile storage medium, that stores instructions and data for execution and use by the processor.

The term “user interface” refers to a logical and graphical arrangement of input and output components presented on a terminal, allowing the user to input information and to receive visual output information from the system.

The term “input area” refers to a display region in the user interface that is configured to receive character information from the user via an input operation.

The term “character information” refers to text data composed of one or more characters that describe at least the user's experience, future goals, and other relevant information in natural language.

The term “communication data format” refers to a structured data representation, such as a serialized text or object structure, that is suitable for transmission between the terminal and the server via a communication protocol.

The term “communication protocol” refers to a set of rules and procedures for transmitting data between devices over a network, including at least a request format, a response format, and error handling procedures.

The term “information processing apparatus” refers to a general-purpose or dedicated computing unit, including at least a processor and a memory, configured to perform data analysis, natural language processing, prompt generation, and response processing.

The term “natural language processing algorithm” refers to a computational procedure or model configured to analyze, interpret, or transform natural language text, including at least tokenization, part-of-speech tagging, and entity extraction.

The term “feature information” refers to structured data derived from character information, including at least job content, skill, desired field, target time, and other extracted attributes that characterize the user's state.

The term “job content” refers to information indicating a type of work or role performed or desired by the user, such as responsibilities, tasks, or occupational categories.

The term “skill” refers to a capability or competency that can be acquired or improved by the user, including technical skills, domain knowledge, and soft skills.

The term “desired field” refers to an area of specialization, industry, or technical domain in which the user wishes to develop or utilize skills.

The term “target time” refers to a temporal condition, such as a period or deadline, within which the user aims to achieve a particular goal or career state.

The term “prompt sentence” refers to a natural-language instruction text generated by the server, specifying processing content and an output format to be executed by a generative AI model.

The term “generative AI model” refers to a machine-learned model configured to generate text or other data in response to input prompts, based on statistical patterns learned from training data.

The term “generative AI model providing apparatus” refers to an external computing resource, including hardware and software, that hosts and executes a generative AI model and provides an interface for receiving prompts and returning generated responses.

The term “authentication information” refers to data used to verify or authorize access to the generative AI model providing apparatus, including at least an identifier, credential, token, or key.

The term “processing conditions” refers to configuration parameters provided to control the behavior of the generative AI model or communication, including at least model selection, response length, and temperature or analogous parameters.

The term “communication request” refers to a data structure formatted for transmission to the generative AI model providing apparatus, including at least a prompt sentence, authentication information, and processing conditions.

The term “response data” refers to data received from the generative AI model providing apparatus in response to a communication request, including at least response character information generated by the generative AI model.

The term “response character information” refers to text generated by the generative AI model based on a prompt sentence and included in the response data.

The term “constituent elements” refers to discrete components identified within response character information, including at least a skill name, a learning item, a learning order, a recommended job, and an action candidate.

The term “skill name” refers to a textual label identifying a specific skill extracted from response character information.

The term “learning item” refers to an individual topic, subject, or activity that the user is advised to study or practice.

The term “learning order” refers to a sequence or prioritization of learning items recommended for the user.

The term “recommended job” refers to a job type, role, or position suggested to the user based on the user's feature information and the generated advice.

The term “action candidate” refers to a suggested activity or step that the user may perform to progress toward a career goal.

The term “advice information structure” refers to a structured data representation that organizes constituent elements extracted from response character information into a normalized format suitable for storage and display.

The term “record information” refers to stored data in the memory that associates the advice information structure with the corresponding prompt sentence and optionally with other session or user identifiers.

The term “visual output information” refers to data defining content and layout of graphical elements for display on a terminal, including at least text, sections, and display areas for advice information.

The term “advice display area” refers to a defined portion of a visual output that presents at least a list of skills, a learning plan, recommended jobs, and action candidates in a segmented manner.

The term “learning plan” refers to an organized arrangement of learning items and learning orders, specifying how and in what sequence the user is recommended to acquire skills.

The term “state type of the user” refers to a classification category assigned to the user based on feature information, such as experience level, domain background, or transition objective.

The term “prompt sentence generation template” refers to a predefined pattern or schema for constructing a prompt sentence, into which feature information can be inserted to produce a complete prompt sentence.

The term “processing policy” refers to an instruction regarding how the generative AI model should frame, focus, or constrain its response, including at least content emphasis and structural requirements.

The term “response structure” refers to a specified organization of the generative AI model's response, including sections, headings, or itemized lists.

The term “content determination processing” refers to an evaluation process applied to response character information, including at least analysis of length, style of expression, and presence or absence of inappropriate content.

The term “filtering process” refers to an operation that removes, masks, or modifies at least a part of response character information based on a result of content determination processing.

The term “display control” refers to a process executed by the server and/or terminal for determining when, where, and how visual output information and advice information structures are presented on a display device.

In one embodiment, a server, a terminal, and a user cooperate to implement a system that generates and utilizes a prompt sentence for a generative AI model in order to provide structured, technically processed career advice. The following description illustrates exemplary hardware and software configurations, data structures, algorithms, model architectures, and technical effects that enable a person skilled in the art to implement the invention.

### A. Overall System Configuration

A server includes at least one processor, a memory, a non-transitory storage medium, and a network interface. The server is implemented, for example, on a virtual machine provided by a data center or cloud platform, and executes an operating system such as a general-purpose server operating system. The server executes application software implemented in a programming language such as Python or Java, using a web application framework such as a typical web service framework. The server further uses libraries for JSON serialization, HTTP communication, and natural language processing, such as a general JSON library, a general HTTP client library, and an open-source natural language processing toolkit.

A terminal includes at least a display device, an input device (such as a touch panel or keyboard), a processor, a memory, and a wireless or wired communication interface. The terminal executes a web browser or a native mobile application. The web browser uses HTML, CSS, and JavaScript to render a user interface. The native application may be developed using typical mobile development frameworks. The terminal communicates with the server via a network using HTTP or HTTPS as a communication protocol.

A generative AI model providing apparatus is implemented as an external computing environment, such as a cluster of graphics processing units (GPUs) or tensor processing units (TPUs). The generative AI model providing apparatus exposes a REST-based API that accepts prompt sentences and returns generated text. The generative AI model is implemented, for example, as a transformer-type neural network trained on large-scale text corpora.

### B. Software Modules and Data Structures on the Server

The server includes multiple software modules stored in the memory and executed by the processor. In one embodiment, the server includes:
(1) A communication module that handles HTTP requests and responses.
(2) A natural language preprocessing module that analyzes character information from the user.
(3) A feature extraction module that extracts feature information such as job content, skill, desired field, and target time.
(4) A user state classification module that classifies a state type of the user.
(5) A prompt generation module that constructs a prompt sentence for a generative AI model.
(6) An AI communication module that constructs communication requests to the generative AI model providing apparatus and receives response data.
(7) A response analysis module that parses response character information.
(8) A content determination and filtering module that evaluates and filters generated text.
(9) An advice structuring module that constructs an advice information structure.
(10) A visual output generation module that generates visual output information for display on the terminal.
(11) A storage management module that stores the advice information structure and its associated prompt sentence as record information.

The server manages specific data structures. For example, the server stores:
(1) A UserInput object containing fields such as experience_text, goal_text, and language.
(2) A FeatureInfo object containing job_content, skill_list, desired_field, target_time, and possibly additional attributes.
(3) A UserState object containing a state_type identifier and confidence scores.
(4) A PromptTemplate object containing a template string with placeholders for feature information.
(5) A PromptRecord object containing a prompt_id, the prompt sentence, feature information, and metadata such as timestamp.
(6) A ModelRequest object containing model identifier, prompt sentence, and processing conditions such as maximum token length and sampling temperature.
(7) A ModelResponse object containing raw generated text, model configuration, and response time.
(8) An AdviceStructure object containing constituent elements such as skill_names, learning_items, learning_order, recommended_jobs, and action_candidates.
(9) A DisplayConfig object specifying how each element of the AdviceStructure is mapped to display regions.

By maintaining these explicit data structures, the server is able to control data flow, optimize processing, and avoid redundant parsing on the terminal side, thereby improving overall computational efficiency.

### C. Natural Language Preprocessing and Feature Extraction

The server applies specific algorithms to the character information. The natural language preprocessing module performs tokenization, sentence splitting, and normalization. The server may use a tokenizer based on regular expressions or a subword segmentation algorithm. The server can apply part-of-speech (POS) tagging and dependency parsing using a statistical or neural NLP model. For example, the server may use a pre-trained sequence labeling model that outputs POS tags for each token.

The feature extraction module uses the output of the preprocessing module and applies rule-based and statistical extraction. The server identifies job_content by searching for noun phrases associated with occupation or role keywords. The server identifies skill candidates by detecting nouns or noun phrases that match a skill lexicon or occur in learned skill clusters. The server identifies desired_field by detecting domain-related entities such as “healthcare,” “finance,” or “AI-powered project management.” The server detects target_time by recognizing temporal expressions such as “within 2 years” or “over the next 12 months” using a time expression recognition algorithm.

The server constructs the FeatureInfo object by assigning extracted values to defined fields. In some embodiments, the server computes a confidence score for each extracted feature using a probabilistic model, and discards low-confidence candidates. This structured feature information enables the downstream modules to construct more precise prompt sentences and reduces the computational overhead required for the generative AI model to infer user context from raw text.

### D. User State Classification and Prompt Template Selection

The server uses a user state classification module to categorize the user into a state type, such as “entry-level,” “mid-career transition to AI,” or “domain expert expanding into data science.” The server may implement this module as a trained classifier, such as a feedforward neural network or a gradient-boosted decision tree model. The classifier receives as input vectorized features derived from FeatureInfo, including representations of job_content, skill_list, desired_field, and target_time.

The classifier outputs a discrete label indicating the state type and may also produce a probability distribution over possible labels. The server stores the label in the UserState object. Based on the state type, the server selects a PromptTemplate from a repository. Each PromptTemplate defines a structured prompt pattern that specifies the required sections in the generative AI model's response, such as “Skills,” “Learning Roadmap,” and “Recommended Roles.”

The use of this classification and template mechanism improves technical performance by constraining the generative AI model's behavior in a systematic way. Instead of sending raw free-text descriptions, the server provides context-dependent, structured instructions, which increases the likelihood that the model returns responses with predictable structure and reduced noise. This in turn simplifies the parsing and display processes and reduces memory and CPU usage for post-processing.

### E. Prompt Sentence Generation

The prompt generation module receives FeatureInfo and UserState and instantiates a PromptTemplate. The server fills placeholders with normalized phrases derived from feature information. For example, the server may generate a prompt sentence such as:

“The user has 3 years of experience in IT project management and wants to work on AI-powered project management in the future. Please provide concrete career advice, including: (1) key technical skills to learn, (2) a 12-month learning roadmap, and (3) example AI-related projects the user can manage to build a portfolio. Answer in clear English with headings and bullet points.”

In another example, the server may generate:
“The user has worked as a backend engineer using a general-purpose programming language for 5 years and wants to transition to a role that uses generative AI models. Please propose: the skills and tools to learn, a step-by-step plan for the next 18 months, and typical job titles the user can aim for. Structure your answer as Skills, Learning Plan, and Target Roles.”

In still another example, the server may generate:
“The user is a university student majoring in business and is interested in combining business strategy with AI. The user has no programming background. Please provide a beginner-friendly, practical roadmap covering foundational skills, recommended courses and activities, and internship ideas for the next 2-3 years. Use simple language and clear bullet points.”

By embedding explicit structural instructions (e.g., headings, bullet points, and time frames) in the prompt sentence, the server shifts some of the structural reasoning from the terminal and downstream modules into the generative AI model itself. This leads to a more predictable response format and reduces the need for complex, resource-intensive heuristic parsing on the server.

### F. Generative AI Model Structure and Training (External but Relevant)

The generative AI model is assumed to be a multi-layer transformer neural network with an encoder-decoder or decoder-only architecture. The model includes multiple attention heads and feedforward layers. The model parameters (weights and biases) have been learned by minimizing a loss function such as cross-entropy over a large training corpus. The model learns to approximate a conditional probability distribution over output tokens given input tokens.

During training, the generative AI model uses gradient-based optimization, such as stochastic gradient descent with adaptive learning rate, and applies regularization methods such as dropout. The model may use positional encodings to capture token ordering and may use layer normalization to stabilize training. Data augmentation may include masking or random cropping of input sequences.

Although the generative AI model is external to the server, the server's specific way of forming prompt sentences, structuring feature information, and specifying processing conditions changes how the model is utilized and leads to technical benefits. The server's algorithmic choices reduce unnecessary exploration in the model's output space and decrease the variance of response structures across requests, which leads to less post-processing computation.

### G. Communication with the Generative AI Model Providing Apparatus

The AI communication module constructs a communication request containing the prompt sentence, authentication information, and processing conditions such as maximum number of output tokens and sampling temperature. The server serializes this information into a JSON-based or similar structure and transmits it using HTTPS. The server may configure timeout and retry policies to manage network reliability and to reduce resource waste due to hanging connections.

The server receives response data containing response character information generated by the generative AI model. The server parses the response using a JSON library, extracts the textual content, and records metadata such as inference latency. Performance metrics can be used to adjust processing conditions for subsequent requests in order to balance response quality and latency.

### H. Response Analysis, Content Determination, and Filtering

The response analysis module applies parsing and segmentation to the response character information. The server splits the text by headings and list markers, such as line breaks and bullet indicators, to identify candidate segments for skills, learning items, and recommended jobs. The server then applies pattern matching and classification rules to map each segment to a constituent element type.

The content determination and filtering module evaluates length, expression style, and the presence or absence of inappropriate content. The server can implement a rule-based engine that checks for profanity, disallowed categories, or unsupported characters. In some embodiments, the server uses a smaller classification model that flags potentially problematic segments. When the module detects problematic content, the server may delete the corresponding segments or replace them with neutral placeholders.

By executing determination and filtering on the server, the system avoids transmitting unnecessary or undesirable data to the terminal. This reduces communication load and prevents the terminal from needing its own complex filtering logic, which is particularly beneficial for resource-constrained mobile devices.

### I. Advice Information Structure and Visual Output Information

The advice structuring module constructs an AdviceStructure object that organizes constituent elements such as skill_names, learning_items, learning_order, recommended_jobs, and action_candidates. The module uses ordered lists and keyed maps to represent relationships between elements, such as which learning items belong to which skill or which actions correspond to which recommended job.

The visual output generation module receives the AdviceStructure and the DisplayConfig and produces visual output information for the terminal. The server specifies a layout in which a skills section, a learning plan section, a roles section, and an actions section are separately defined. The server may generate a structured representation (for example, a markup-like description) that indicates headings, lists, and formatting instructions.

By sending already-structured, display-ready data, the server reduces the amount of logic needed on the terminal to format complex advice. The terminal only maps the data to visual components, resulting in shorter render times and less CPU and memory usage. This is a technical improvement over systems that send raw, unstructured text and rely on each client implementation to parse and format the content independently.

### J. Technical Effects and Computer-Technology Improvements

The server improves computer technology in several ways. First, the server's feature extraction and user-state classification modules reduce the entropy of the input provided to the generative AI model. By doing so, the server decreases the average length and complexity of model outputs needed to reach an adequate level of personalization, thereby reducing both inference time on the generative AI model providing apparatus and parsing time on the server.

Second, the use of structured PromptTemplate objects and AdviceStructure objects allows the system to standardize and compress communication between server and terminal. For example, instead of sending arbitrary paragraphs, the server sends lists of labeled elements (skills, learning items, etc.), which can be encoded efficiently and rendered with minimal computation. This structure also allows caching and re-use of advice segments, further reducing computational overhead.

Third, the centralized content determination and filtering module, executed on the server, avoids the duplication of filtering logic on each terminal platform and ensures consistent enforcement of content policies. This enhances reliability and reduces the need for multiple redundant implementations.

Fourth, the specific interaction pattern between the server and the generative AI model-namely, using extracted feature information and user state classification to select a prompt template and generate a prompt sentence that constrains response structure-improves the predictability and machine-parseability of the generated output. Instead of simply automating a human task, the system introduces a non-conventional division of labor: the server handles structural and safety-related reasoning, while the generative AI model focuses on content generation within a constrained format. This division allows the computing system as a whole to operate with improved performance metrics, such as reduced average response size, reduced error rate in advice parsing, and improved latency for end users.

Finally, the system enables more efficient data management by associating each AdviceStructure with the corresponding prompt sentence and feature information in record information. This association supports later analysis, comparison, and refinement of prompts, which can further optimize the operation of the generative AI model and the surrounding infrastructure.

### K. Alternative Embodiments and Variations

In another embodiment, the terminal performs a subset of preprocessing operations, such as basic input validation or text normalization, before sending character information to the server. In this case, the server still performs the core natural language processing, feature extraction, and prompt generation, preserving the central technical improvements described above.

In another embodiment, the server employs different types of classifiers for user state classification, such as a recurrent neural network or a convolutional neural network applied to sentence embeddings. Alternatively, the server may use a rule-based classifier for environments where training data is limited, while still using the same PromptTemplate and AdviceStructure mechanisms.

In yet another embodiment, the generative AI model providing apparatus hosts models with different sizes and capabilities. The server dynamically selects a model identifier in the ModelRequest based on current system load, required response speed, or user priority level. By dynamically adapting the model choice, the server can balance quality and performance, which is a technical optimization at the system level.

In another embodiment, the server stores aggregated statistics about generated responses, such as average response length per state type and failure rates of parsing. The server uses these statistics to adjust prompt patterns and processing conditions, creating a feedback loop that continually refines the operational parameters for improved efficiency.

Through these embodiments and variations, the server, terminal, and generative AI model providing apparatus cooperate to implement a technically grounded system that processes user character information into optimized prompt sentences and structured advice, yielding concrete improvements in processing efficiency, communication load, and consistency of output, rather than merely automating a human advisory task.

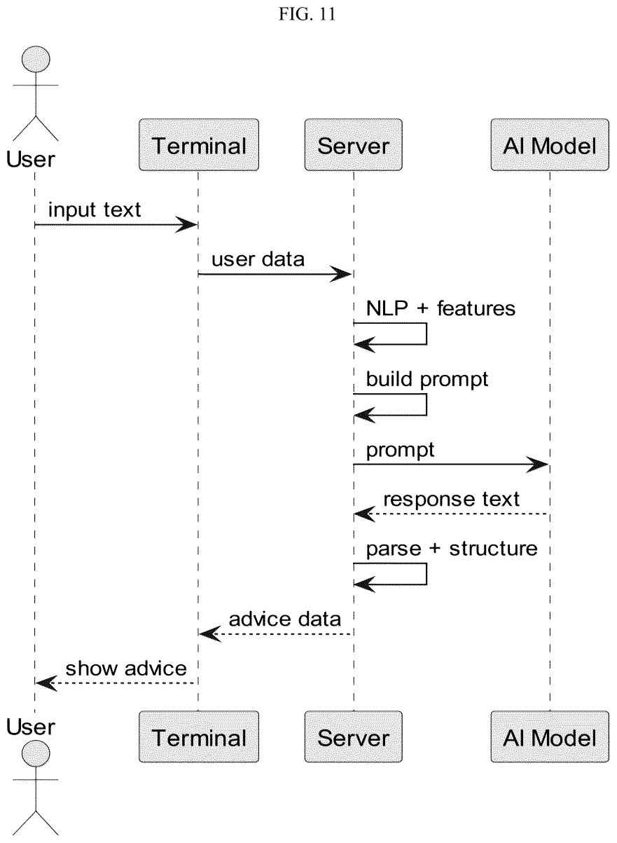

The following describes the processing flow using FIG. 11.

### Step 1:

User operates a terminal to access a user interface provided by the server.

User inputs character information describing experience and future goals into an input area on the display.

Input: Free-text character information (e.g., “I have 3 years of IT project management experience and want to work on AI-powered projects”).

Output: Text data temporarily stored in the terminal's memory and held as a local input object.

### Step 2:

Terminal validates and structures the user's character information.

Terminal checks that mandatory fields are not empty and that the text length does not exceed a predetermined limit, using client-side validation logic.

Terminal converts the character information and related fields (e.g., language, user identifier) into a communication data format such as a JSON object.

Input: Raw text data from the user and local UI state.

Output: A structured data object containing at least fields for experience text, goal text, and metadata, ready for transmission to the server.

### Step 3:

Terminal transmits the structured data to the server.

Terminal serializes the structured data into a byte sequence and sends it as the body of an HTTP or HTTPS request to an API endpoint exposed by the server.

Terminal sets request headers such as content type and authentication tokens, and then uses a network interface to send the request.

Input: Structured data object representing user input.

Output: A network message containing the serialized user input data delivered to the server.

### Step 4:

Server receives and parses the communication data from the terminal.

Server accepts the HTTP or HTTPS request via a communication module, reads the request body, and deserializes the data using a JSON parser.

Server maps the parsed data into an internal UserInput object with well-defined fields (experience_text, goal_text, language, and user_id).

Input: Serialized user input data embedded in the network message.

Output: A UserInput object stored in server memory and accessible to subsequent processing modules.

### Step 5:

Server performs natural language preprocessing on the character information.

Server passes the experience_text and goal_text to a natural language preprocessing module that performs tokenization, sentence segmentation, and normalization (e.g., lowercasing, removal of extra whitespace).

Server may also apply part-of-speech tagging and syntactic parsing using a natural language processing algorithm.

Input: UserInput object containing raw character information.

Output: A preprocessed text representation, including token lists, sentence boundaries, and linguistic tags associated with the input text.

### Step 6:

Server extracts feature information from the preprocessed text.

Server uses pattern-based rules and statistical models to identify phrases corresponding to job content, skills, desired field, and target time.

Server constructs a FeatureInfo object by assigning detected phrases and computed confidence scores to corresponding fields.

Input: Preprocessed text representation with linguistic annotations.

Output: A FeatureInfo object containing job_content, skill_list, desired_field, target_time, and optionally other attributes that describe the user's state.

### Step 7:

Server classifies a state type of the user based on the feature information.

Server converts FeatureInfo into a numerical feature vector (e.g., through embedding or one-hot encoding) and feeds it into a classification model, such as a neural network or a decision tree-based model.

Server obtains a state_type label (e.g., “mid-career transition to AI”) and an associated probability distribution.

Input: FeatureInfo object describing the extracted elements of the user's text.

Output: A UserState object containing a state_type label and confidence values used for downstream decisions.

### Step 8:

Server selects a prompt template according to the classified state type.

Server accesses a repository of PromptTemplate objects and retrieves a template that is associated with the state_type indicated in the UserState object.

Server ensures that the selected template defines placeholders for at least skills, learning periods, and role descriptions, as well as structural instructions for the response.

Input: UserState object with state_type and a set of available PromptTemplate objects.

Output: A selected PromptTemplate object specifying a structural pattern for the prompt sentence.

### Step 9:

Server generates a prompt sentence for the generative AI model.

Server replaces placeholders in the PromptTemplate with specific phrases from FeatureInfo (e.g., job_content, desired_field, experience duration).

Server creates a coherent natural-language instruction string that directs the generative AI model regarding processing content and response structure, such as:

“The user has 3 years of experience in IT project management and wants to work on AI-powered project management in the future. Please provide concrete career advice, including: (1) key technical skills to learn, (2) a 12-month learning roadmap, and (3) example AI-related projects the user can manage to build a portfolio. Answer in clear English with headings and bullet points.”

Input: FeatureInfo object and PromptTemplate object.

Output: A prompt sentence stored in a PromptRecord together with associated feature information and metadata.

### Step 10:

Server prepares a request for the generative AI model providing apparatus.

Server constructs a ModelRequest object that includes at least a model identifier, the prompt sentence, and processing conditions such as maximum output length and sampling temperature.

Server embeds authentication information (e.g., tokens, keys) and the ModelRequest data into a communication request formatted for a REST API.

Input: PromptRecord containing the prompt sentence and configuration parameters.

Output: A serialized communication request ready for transmission to the generative AI model providing apparatus.

### Step 11:

Server sends the communication request to the generative AI model providing apparatus and receives response data.

Server transmits the request via HTTPS to an endpoint exposed by the generative AI model providing apparatus and waits for a response within a configured timeout.

Server receives a response containing response character information generated by the generative AI model based on the prompt sentence, and deserializes this response into a ModelResponse object.

Input: Serialized communication request including the prompt sentence and processing conditions.

Output: A ModelResponse object containing the generated text and any associated metadata, such as inference time and model version.

### Step 12:

Server analyzes and segments the response character information.

Server extracts the main text from the ModelResponse and splits it into logical segments based on headings, bullet points, numbering, and line breaks.

Server assigns provisional labels (e.g., potential skills, potential learning items) to each segment using pattern matching and rules tailored to the expected structure indicated in the prompt sentence.

Input: ModelResponse object with raw generated text.

Output: An intermediate segmented representation in which portions of the text are mapped to candidate categories.

### Step 13:

Server performs content determination processing and filtering on the segmented text.

Server evaluates each segment for length limits, expression style, and presence or absence of inappropriate or disallowed content, using rule-based checks and optionally a small content classifier.

Server deletes, masks, or replaces segments that violate content criteria and may compress overly long segments by truncation or summarization.

Input: Segmented representation of the generated text.

Output: A cleaned and filtered set of segments suitable for direct use in advice generation, with labels preserved or adjusted as needed.

### Step 14:

Server structures the filtered segments into an advice information structure.

Server maps each filtered segment to a defined constituent element type, such as skill_name, learning_item, learning_order, recommended_job, or action_candidate, according to predefined mapping rules and the labels assigned in previous steps.

Server creates an AdviceStructure object that organizes these elements into ordered lists and keyed associations, for example linking a learning_item to a corresponding skill_name or aligning action_candidates with recommended_jobs.

Input: Filtered and labeled text segments.

Output: An AdviceStructure object representing normalized, machine-structured advice data.

### Step 15:

Server associates the advice information structure with the original prompt sentence and stores record information.

Server creates or updates a PromptRecord to include references to both the generated prompt sentence and the resulting AdviceStructure together with user identifiers and timestamps.

Server writes this record information to a persistent storage medium using the storage management module, enabling later retrieval, analysis, or reuse.

Input: AdviceStructure object and the PromptRecord containing the prompt sentence.

Output: A stored record entry that persistently links the prompt sentence, input features, and structured advice.

### Step 16:

Server generates visual output information for the terminal.

Server reads the AdviceStructure and uses a DisplayConfig to determine the layout of skills, learning plan, recommended roles, and action candidates across distinct display regions.

Server constructs a visual output description that specifies headings, lists, grouping, and ordering of items, such as a section “Skills to Learn,” a section “Learning Roadmap,” and a section “Recommended Roles and Actions.”

Input: AdviceStructure object and DisplayConfig object.

Output: A visual output information object describing how advice elements should be presented on the terminal.

### Step 17:

Server transmits the visual output information to the terminal.

Server serializes the visual output information into a structured format and sends it as part of an HTTP or HTTPS response to the terminal that initiated the request.

Server may also include supplementary metadata (e.g., identifiers, timestamps) to support caching or future updates.

Input: Visual output information object.

Output: A network response containing the structured visual output information delivered to the terminal.

### Step 18:

Terminal renders the received visual output information to the user.

Terminal parses the structured visual output, maps each element to user interface components (such as headings, list items, and clickable entries), and updates the display accordingly.

Terminal presents separated sections for skill names, learning items arranged in learning order, recommended jobs, and specific action candidates, making use of the terminal's graphics subsystem to draw textual and graphical elements.

Input: Structured visual output information from the server.

Output: A rendered screen on the terminal that visually presents structured career advice to the user.

### Step 19:

User reviews the displayed advice and may optionally refine the input.

User reads the skills, learning plans, recommended roles, and action candidates and may decide to modify previous experience or goals by entering additional details into the input area.

User initiates a new cycle by submitting updated character information, which becomes new input to the terminal and server, thereby repeating the above processing with refined data.

Input: Visual presentation of advice and user's new or modified intentions.

Output: Updated character information generated by the user for subsequent processing in another cycle.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional information processing systems that utilize machine learning models, including generative AI models, the computer is often used merely as a passive conduit that forwards user input to an external model and returns the raw output to the user. In such architectures, the processor does not actively transform the user data or the model output in a manner that improves the operation of the computer itself. As a result, several technical problems arise.

First, existing systems generally fail to automatically construct an appropriate prompt sentence for a generative AI model based on heterogeneous user inputs such as experience information and future objective information. The processor typically receives free-form text from the user and either passes it directly to the model or applies only minimal preprocessing. This leads to inefficient use of computing resources because the generative AI model receives ambiguous or poorly structured instructions, which can cause unnecessary token usage, repeated inference calls, and inconsistent output structures that must be manually interpreted or reformatted.

Second, conventional systems do not adequately align the generated content with user-specific attributes or preferences in a way that is integrated into the computer's processing pipeline. The model output is often returned as a monolithic text stream without structured segmentation, prioritization, or ranking in view of user profiles. As a consequence, the processor must either perform expensive post-hoc processing or simply display long and noisy content, which degrades responsiveness, increases memory usage, and fails to leverage the available user context to optimize both computation and presentation.

Third, existing systems typically lack an iterative control loop at the computer system level that closes the feedback path between user evaluation, prompt regeneration, and content selection. Even when users provide additional conditions or feedback, this information is not systematically incorporated into a refined prompt sentence and subsequent ranking of sections of the generated content. This absence of a structured feedback mechanism results in repeated, ad-hoc calls to the generative AI model, inefficient re-processing of largely similar data, and redundant rendering operations on the user terminal.

Fourth, many known solutions do not provide a robust mechanism for structurally transforming generated content into a machine-friendly format that can be efficiently transmitted over a communication network, stored in memory, and rendered on a display device. Without explicit structuring into sections with heading information, body information, and section information, the system must repeatedly parse and format the same data for each interaction, causing increased processor load, network bandwidth consumption, and latency.

Therefore, there is a need for an improved computer-implemented system in which the processor automatically (i) performs natural language processing on user experience information and future objective information, (ii) generates a prompt sentence that precisely specifies processing type, output amount, output structure, and output language for a generative AI model, (iii) structures and evaluates the generated content in multiple sections based on user-related data, and (iv) iteratively refines the prompt and content selection in response to user feedback. Such a system should enhance the efficiency, reliability, and usability of the computer's overall operation by reducing unnecessary model invocations, optimizing content selection and formatting, and enabling the display subsystem to present tailored, structured information with reduced computational overhead.

The specific processing by the specific processing unit 290 of the data processing device 12 in Application Example 1 is realized by the following means.

The present invention provides a server comprising a processor and a memory, the processor being configured to provide, to a user terminal via a communication network, an input interface that receives user experience information and user future objective information as character information, to store the received user experience information and user future objective information in the memory in association with user-related preference information or attribute information, to perform a natural language processing operation on the stored user experience information and future objective information including at least one of normalization, syntactic analysis, important term extraction, and summarization, to generate, based on a result of the natural language processing operation, a prompt sentence for a generative AI model including instruction information specifying at least a processing type, an output amount, an output structure, and an output language, to transmit the prompt sentence to the generative AI model and acquire, from the generative AI model, generated content including information related to the user experience information and the user future objective information, to divide the generated content into a plurality of sections and calculate, for each section, an evaluation value on the basis of at least one of phrase similarity with the user experience information and the user future objective information, a weight determined from the preference information, and an information amount of the section, to select sections as selected content by ranking the sections according to the evaluation values and adopting only sections having a rank equal to or higher than a predetermined rank, to convert the selected content into structured content including at least heading information, body information, and section information, to transmit the structured content to the user terminal via the communication network, and to control iterative processing in which, in response to additional conditions or evaluation information received from the user terminal, the processor regenerates the prompt sentence and repeats acquisition, selection, structuring, and transmission of content. This enables the computer system to more efficiently utilize generative AI resources, reduce redundant computation and data transmission, and improve the technical performance of content generation, selection, and display by automatically tailoring and structuring the generated information in accordance with user-specific context and feedback.

The term “processor” refers to a hardware computation element, such as a central processing unit or an execution core, that executes instructions to perform arithmetic, logic, control, and input/output operations required to implement the functions of the system.

The term “memory” refers to a hardware storage resource, such as a volatile or non-volatile storage device, that stores instructions, user data, intermediate processing results, and configuration information used by the processor.

The term “user terminal” refers to an information processing device operated by a user, such as a portable communication device, a general-purpose computer, or a display device, that communicates with the server via a communication network and presents information to the user.

The term “communication network” refers to a wired or wireless data transmission infrastructure, including local area networks, wide area networks, and public communication networks, that enables data exchange between the server, the user terminal, and external information processing apparatuses.

The term “input interface” refers to a logical and physical arrangement of software and hardware components, such as graphical user interface elements and input drivers, that enables the user to enter character information including experience information and future objective information into the system.

The term “experience information” refers to character-based information indicating a user's past activities, skills, roles, or knowledge, which is used as input data for generating a prompt sentence and related content.

The term “future objective information” refers to character-based information indicating a user's desired future state, goals, or targets, which is used as input data for generating a prompt sentence and related content.

The term “preference information” refers to data stored in association with a user that indicates the user's likes, dislikes, content format preferences, difficulty level preferences, or other configuration parameters affecting selection and presentation of generated content.

The term “attribute information” refers to data associated with a user, such as role, field, proficiency level, or demographic characteristics, that is used to control selection, ranking, and formatting of generated content.

The term “generative information processing model” refers to a machine-implemented model, such as a trained neural network, that receives a prompt sentence as input and outputs generated content in the form of character information or structured data based on learned patterns.

The term “prompt sentence” refers to instruction information represented as character data that specifies at least a processing type, an output amount, an output structure, and an output language to be executed by the generative information processing model.

The term “instruction information” refers to information embedded in or associated with a prompt sentence that constrains or specifies how the generative information processing model should process input data and format its output.

The term “generated content” refers to information output by the generative information processing model in response to a prompt sentence, including text, sections, or other data related to the user's experience information and future objective information.

The term “selection process” refers to a series of operations performed by the processor to evaluate, filter, and choose at least part of the generated content according to predetermined criteria, such as importance, relevance, or correlation with user-related data.

The term “formatting process” refers to a series of operations performed by the processor to reshape or reorganize generated content, including operations such as removal of unnecessary portions, adjustment of length, insertion of headings, and conversion into structured formats.

The term “structured content” refers to generated content that has been transformed into a data structure including at least heading information, body information, and section information, thereby enabling efficient transmission, storage, and display.

The term “heading information” refers to a portion of structured content that succinctly represents the title, topic, or label of a section, and is used to visually distinguish or summarize that section for the user.

The term “body information” refers to a portion of structured content that includes the principal explanatory text, details, or substantive information associated with a heading.

The term “section information” refers to data that indicates boundaries, identifiers, or relationships between different parts of the structured content, thereby defining multiple sections within the generated content.

The term “natural language processing operation” refers to one or more computational techniques applied to character-based input, including normalization of character types, syntactic analysis, extraction of important terms, and summarization, for the purpose of improving prompt sentence generation and content handling.

The term “normalization” refers to a process of converting character-based data into a standardized representation, such as harmonizing character encodings, unifying character variants, or regularizing whitespace and punctuation.

The term “syntactic analysis” refers to a process of analyzing the grammatical structure of text, such as identifying parts of speech or dependency relations, in order to better understand the relationships between words and phrases.

The term “important term extraction” refers to a process of identifying words or phrases in text that carry significant semantic weight or are highly relevant to the user's experience information and future objective information.

The term “summarization” refers to a process of condensing longer text into shorter text while preserving essential meaning, key points, or main topics.

The term “processing type” refers to a category or mode of operation specified in the prompt sentence that indicates how the generative information processing model should treat input data, such as explanation generation, recommendation generation, or roadmap generation.

The term “output amount” refers to a quantity-related specification in the prompt sentence that constrains the length, number of items, or level of detail of the content produced by the generative information processing model.

The term “output structure” refers to a specification in the prompt sentence that defines how the generative information processing model should organize its output, such as by headings, bullet points, numbered lists, or multi-section layouts.

The term “output language” refers to a specification in the prompt sentence that indicates the natural language in which the generative information processing model is requested to generate its output.

The term “section” refers to a logically delimited part of the generated content, typically corresponding to a unit of meaning, topic, or function that is treated as an independent element in selection and ranking.

The term “evaluation value” refers to a numerical or comparable value calculated for each section of the generated content on the basis of one or more criteria, which is used to rank and select sections.

The term “phrase similarity” refers to a quantitative or qualitative measure of similarity between phrases in a section and phrases in the user's experience information or future objective information, computed by a predetermined algorithm.

The term “information amount” refers to a measure of the quantity or richness of information contained in a section, which may be based on factors such as length, diversity of terms, or presence of key concepts.

The term “additional conditions” refers to supplementary requests, constraints, or clarifications provided by the user after initial content has been generated, which are used to refine a subsequent prompt sentence.

The term “evaluation information” refers to feedback data provided by the user, such as ratings, selections, or comments, indicating the usefulness or adequacy of generated content.

The term “iterative processing” refers to a repeated sequence of operations in which the processor regenerates a prompt sentence using additional conditions or evaluation information, re-invokes the generative information processing model, and re-applies selection and formatting processes to produce refined content.

In one embodiment, a server, a terminal, and a user cooperate to implement the invention.

The server includes at least one processor, a main memory, a non-volatile storage device, a network interface, and a display interface (for administrative monitoring). The processor may be implemented by a general-purpose central processing unit or a plurality of such units. The main memory may be implemented by a semiconductor memory device such as a dynamic random access memory, and the non-volatile storage device may be implemented by a magnetic disk, a solid-state drive, or an equivalent storage apparatus. The server executes an operating system such as a general-purpose server operating system and application software including a web server, an application framework, and a database management system.

The terminal includes at least one processor, a memory, a display device such as a liquid crystal display or an organic light-emitting diode display, an input device such as a touch panel, and a wireless or wired communication interface. The terminal executes an operating system such as a mobile operating system and a dedicated application program that communicates with the server. The user operates the terminal to input experience information and future objective information and to view content returned from the server.

The server executes an application comprising a plurality of software modules including at least: a communication module, a user profile management module, a natural language processing module, a prompt generation module, a generative AI interface module, a content structuring module, a content selection and ranking module, and a presentation control module. Each module is implemented by instructions executed by the processor and cooperates via shared data structures stored in the memory and the storage device.

The terminal executes an application including at least: a user interface module, a local validation module, a communication module, and a display formatting module. The terminal application is implemented, for example, using a mobile application framework such as a native application framework for handheld devices. The user interface module presents text input fields, buttons, and scrollable views; the communication module transmits and receives data via a secure communication protocol such as HTTPS.

The server manages user-related data using a database management system such as a relational database. The server stores, in tables or equivalent data structures, user identifiers, experience information, future objective information, preference information, and attribute information. Each record may include fields such as a user identifier, language preference, domain preference, detail level preference, and timestamps. The server uses structured query language or an object-relational mapping library to retrieve and update records.

The server uses a generative AI model that is implemented as a neural network architecture having multiple layers. In one embodiment, the generative AI model is a transformer-based language model comprising an embedding layer, a plurality of self-attention layers, feed-forward layers, and a final output projection layer. The model receives a sequence of tokens representing a prompt sentence and outputs a sequence of tokens representing generated content. The model parameters include, for example, weight matrices in the attention mechanisms, biases in the feed-forward networks, and embedding vectors. The generative AI model is trained in advance by a learning algorithm such as stochastic gradient descent or a variant thereof. During training, the model minimizes a loss function such as cross-entropy between predicted token distributions and ground-truth tokens using a large text corpus. The server accesses the trained generative AI model via an application programming interface exposed by a model-serving system. The model-serving system executes inference operations using an accelerator such as a graphics processing unit.

The server uses the generative AI model in a manner that goes beyond simply forwarding user text. The server generates a prompt sentence that encodes structured instruction information. The natural language processing module analyzes the user's experience information and future objective information using algorithms such as tokenization, part-of-speech tagging, dependency parsing, and statistical or neural key phrase extraction. The server normalizes character encodings, standardizes character types (for example, converting full-width characters to half-width characters where appropriate), removes malformed characters, and resolves simple orthographic variants. The server then computes scores for terms appearing in the input text using techniques such as term frequency or inverse document frequency or neural attention weights, and selects important terms that characterize the user's domain and goal.

The prompt generation module uses the result of this analysis to construct a prompt sentence in which the user's experience information and future objective information are inserted into predefined sections and where the desired processing type, output structure, output amount, and output language are explicitly encoded. For example, the server constructs a prompt sentence such as:
“User's experience: project management in software development.
User's goal: manage AI-powered projects in the future.

Based on this profile, generate:
1. Current trends in AI-powered project management,
2. Real-world case studies,
3. A 3-month learning roadmap for the user.
Write in English with clear headings and bullet points.”

In another example, the server constructs a prompt sentence such as:
“User's experience: marketing project management.
User's goal: use AI tools to improve campaign planning and performance analysis.
Based on this profile, generate actionable suggestions, concrete tool examples, and realistic scenarios where AI improves marketing project outcomes.
Output three sections, each with a heading and concise bullet points, in English.”

By encoding explicit structural and quantitative constraints in the prompt sentence, the server controls the generative AI model so that the model outputs content in a machine-parsable and user-appropriate format. This reduces ambiguity and unnecessary token generation, which in turn improves computational efficiency and reduces latency on the model-serving hardware. The generative AI interface module of the server sends the prompt sentence and model parameters to the generative AI model via the network interface. The server specifies, for example, a temperature parameter to control randomness, a maximum number of tokens to limit computation, and a stop condition to terminate generation when a section boundary or an end symbol is produced. The server receives generated content as a sequence of tokens and decodes the tokens into character information using a tokenizer and a decoding table maintained in memory.

The content structuring module of the server processes the generated content. The server identifies section boundaries based on markers requested in the prompt sentence, such as headings indicated by capitalized lines, numbered items, or delimiter phrases. The server constructs an internal data structure that represents each section as a record containing at least heading information, body information, and section information such as a section identifier and relative order. The server may further compute metadata such as estimated reading time or a coverage score indicating how many important terms from the user's input are present in the section.

The content selection and ranking module then computes an evaluation value for each section. The server compares tokens in each section with tokens representing the user's experience information and future objective information. For this purpose, the server applies algorithms such as cosine similarity between vector representations of phrases or simple overlap measures between normalized tokens. The server also uses preference information and attribute information stored for the user to adjust weights in the evaluation. For example, if the user's preference indicates a higher priority for “roadmap” content, the server increases the evaluation values of sections that contain terms related to steps, timelines, or learning paths. The server may also penalize sections that exceed a length threshold or that have low term diversity.

The server ranks the sections based on the evaluation values and selects only sections whose ranks are equal to or higher than a predetermined rank or whose evaluation values exceed a threshold. By doing so, the server discards less relevant or redundant content before transmission. This ranking and selection based on user-related data is executed automatically by the processor and uses quantitative criteria that are difficult for a human operator to apply consistently and in real time.

The content structuring module further formats the selected sections into structured content. The server converts the internal data structure into a transmission format adapted to the terminal, including explicit fields for heading information, body information, and section boundaries. The server may compress the structured content or remove low-priority metadata when network conditions are poor. This structured representation reduces the amount of data transmitted relative to unstructured long text and enables the terminal to apply efficient rendering techniques.

The presentation control module of the server instructs the terminal on how to display the structured content. For example, the server may include style hints or layout hints such as “display three headings as tabs” or “show bullet points with indentation.” The terminal receives these hints and formats the content using a user interface framework. The terminal does not need to perform heavy natural language analysis or re-structuring of the content. This offloading of complex processing to the server allows the terminal to consume less battery power and memory resources.

The user can provide additional conditions or evaluation information through the terminal after reviewing the displayed content. For instance, the user may input a request such as “please provide more technical implementation details and fewer introductory explanations” or may rate each section with an explicit score. The terminal transmits this information to the server. The server updates the preference information and attribute information stored for the user and modifies the prompt generation behavior. For example, the server may construct a revised prompt sentence such as:
“User's experience: project management in software development.
User's goal: manage AI-powered projects in the future.
Additional request: focus on concrete technical implementation steps and reduce general introductions.
Generate three sections with detailed, technical bullet points suitable for an experienced practitioner.
Write in English.”

The server thereby establishes an iterative loop: the server uses evaluation information and additional conditions to regenerate the prompt sentence, to invoke the generative AI model again, and to recalculate evaluation values of newly generated sections. This feedback loop is realized entirely by adjustments to the data structures and algorithms executed by the processor. It enables the system to converge to tailored content more quickly than a human operator could manually refine text and repeatedly request content.

The described configuration yields technical effects beyond simple automation of human tasks. Because the server analyzes user inputs and generated outputs at the token and section level, and because the server controls the generative AI model through structured prompt sentences specifying processing type, output amount, and output structure, the server reduces redundant tokens and avoids generating content that will later be discarded. This reduces total inference time on the neural network hardware and saves network bandwidth. The selection and ranking module further avoids transmitting low-relevance sections. As a result, the system achieves lower end-to-end latency, reduced processing load on both the server and the terminal, and improved utilization of memory and cache resources.

In addition, the structured content representation improves data management. The server and the terminal can index sections by identifiers, store them separately, and perform partial updates without re-transmitting entire documents. For example, when only a single section needs revision based on new feedback, the server can regenerate and transmit only that section. This granular control is enabled by the specific data structures and algorithms used to divide and annotate content, and it reduces storage and communication overhead.

In one variation, the generative AI model is integrated within the same physical server, and the server executes both the application logic and the neural network inference on a graphics processing unit inside the server housing. In another variation, the generative AI model is hosted on a remote computing platform, and the server acts as a client to the remote model-serving system. In both cases, the server applies the same prompt generation, evaluation, and selection algorithms, and the same technical advantages are obtained.

In another embodiment, the server uses a different neural network architecture, such as a recurrent neural network with attention or a hybrid architecture that combines convolutional layers and attention layers. The training method may employ supervised fine-tuning using human-labeled examples of preferred outputs, followed by reinforcement learning with a reward model that reflects user satisfaction scores. The reward model may be trained on evaluation information collected from users. By using such a training scheme, the generative AI model can adapt its output distribution to produce content that more often contains features that the selection and ranking module will score highly, thereby further improving overall system efficiency.

In yet another embodiment, the server maintains multiple generative AI models specialized for different domains, such as software development, marketing, or healthcare. The server selects an appropriate model based on the user's attribute information. The prompt generation module may include a model selection field in the instruction information, and the generative AI interface module routes the prompt sentence to the selected model. This architecture reduces the average length of prompts and responses for each domain and improves inference accuracy, thereby decreasing the number of iterations required to satisfy the user.

The system is thus not limited to a specific business domain and can be applied in various contexts where user-specific experience information and future objective information are used to produce tailored content. Nevertheless, the core technical improvement resides in the cooperation between the server's data analysis algorithms, structured prompt sentence generation, model control, and section-level selection and structuring, which together improve the performance and operation of the computer system itself.

In all of these embodiments, the server, the terminal, and the user interact within a defined computational framework. The server performs specific data transformations and algorithmic operations that are not mere mental steps, and the use of the generative AI model is tied to concrete improvements in processing speed, relevance accuracy, memory management, and communication efficiency. Therefore, the invention provides a technical solution to problems in computer-based content generation and presentation by optimizing internal data structures, control flows, and neural network utilization, rather than simply automating human reasoning.

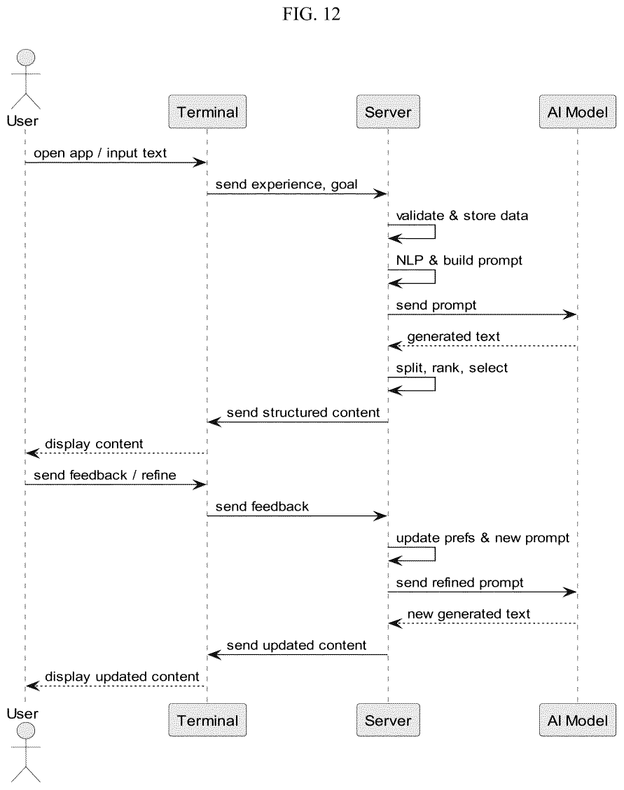

The following describes the processing flow using FIG. 12.

### Step 1:

The user operates the terminal to launch an application and open an input screen.

The terminal displays text input fields for experience information and future objective information, and a send button.

Input: blank text fields and UI controls.

The user inputs free-form text describing past experience and future objectives, and the terminal receives this character data.

The terminal performs local checks, such as verifying that the fields are not empty and that the total character length is within a predetermined limit.

The terminal converts the text to a unified encoding (for example, UTF-8), trims extra whitespace, and prepares an internal data structure containing a user identifier, the experience text, the future objective text, and a timestamp.

Output: validated, normalized user input data ready for transmission.

### Step 2:

The terminal uses a communication library to serialize the user input data into a request message, for example in JSON format, and sets HTTP headers including content type and authentication information.

Input: validated user input data (user identifier, experience text, future objective text).

The terminal transmits an HTTPS request containing the serialized data to the server's API endpoint via a communication network.

The server receives the request, reads the HTTP headers and body, and passes the body to an application framework for further processing.

Output: a parsed request object on the server side that includes the raw user input fields.

### Step 3:

The server parses the received serialized data to reconstruct the user identifier, experience text, and future objective text as internal variables.

Input: serialized request message received from the terminal.

The server validates the data by checking required fields, verifying data types, and enforcing length and format constraints.

The server performs a normalization process that includes character encoding normalization, conversion of special characters, trimming of leading and trailing spaces, and unification of line endings.

The server generates a normalized user profile object stored temporarily in memory.

Output: a validated and normalized user profile object containing experience information and future objective information.

### Step 4:

The server accesses a database management system and executes data manipulation operations to persist the user profile.

Input: normalized user profile object in memory.

The server constructs an insert or update command specifying columns such as user identifier, experience text, future objective text, language preference, and timestamps, and sends this command to the database engine.

The database engine writes the data to non-volatile storage and returns a success or failure status.

The server receives the status and, on success, associates a profile record identifier with the user profile object in memory.

Output: a stored profile record in the database and an in-memory profile object linked to that record.

### Step 5:

The server retrieves preference information and attribute information associated with the user from the database or a cache.

Input: user identifier and profile record identifier.

The server queries preference tables or profile tables and obtains data such as preferred language, content length, detail level, and domain.

The server merges this information into the in-memory profile object, resulting in an enriched context for subsequent processing.

Output: a context object containing experience information, future objective information, preference information, and attribute information.

### Step 6:

The server applies a natural language processing module to the experience text and the future objective text.

Input: text fields from the context object (experience and future objective).

The server tokenizes the text into words or subword units, performs part-of-speech tagging, and executes syntactic analysis to determine dependencies between tokens.

The server calculates term importance scores using methods such as term frequency or neural attention, and extracts important terms representing key skills, domains, and goals. The server optionally summarizes long texts by selecting key sentences using scoring algorithms based on coverage of important terms.

Output: processed linguistic data including token sequences, syntactic structures, important terms, and optional summaries.

### Step 7:

The server uses the processed linguistic data and the user preferences to construct a prompt sentence for a generative AI model.

Input: processed linguistic data and the context object (including preferences and attributes). The server selects a processing type, such as trend explanation, case study generation, or roadmap creation, based on the user's domain and objective.

The server composes a multi-part instruction that encodes output structure (for example, headings and bullet points), output amount (for example, number of sections), and output language.

The server inserts normalized experience text and future objective text into template phrases and appends explicit instructions.

For example, the server generates a prompt sentence such as:

“User's experience: project management in software development.

User's goal: manage AI-powered projects in the future.

Based on this profile, generate:
1. Current trends in AI-powered project management,
2. Real-world case studies,
3. A 3-month learning roadmap for the user.
Write in English with clear headings and bullet points.”

Output: a structured prompt sentence string tailored to the user's profile and preferences.

### Step 8:

The server configures parameters for the generative AI model, such as model identifier, temperature, maximum token count, and stop conditions.

Input: prompt sentence and configuration rules for the generative AI model.

The server constructs an API request containing the prompt sentence and parameter values and sends it via a network interface to a model-serving system that hosts the generative AI model.

The model-serving system executes neural network inference on specialized hardware, processes the tokenized prompt, and returns generated tokens representing the model's response.

The server receives the model response and decodes the tokens into text.

Output: raw generated content as a text string or sequence of text segments.

### Step 9:

The server processes the raw generated content to identify and separate individual sections.

Input: raw generated content text.

The server scans the text for patterns such as numbered lists, line breaks, or heading markers, and splits the content into sections.

The server constructs internal section objects, each containing at least heading text, body text, and a section index.

The server may compute basic statistics for each section, such as character count and term distribution.

Output: a collection of section objects representing the generated content in structured form.

### Step 10:

The server evaluates each section object against the user's experience information, future objective information, and preference information.

Input: collection of section objects and the context object.

The server calculates phrase similarity scores by comparing normalized tokens in each section with tokens from the user's input, using, for example, cosine similarity on embedded vectors or token overlap ratios.

The server adjusts these scores using weights derived from preference information, such as prioritizing sections that contain roadmap-related terms if the user prefers actionable plans. The server optionally calculates an information amount metric based on length and diversity of terms.

The server combines similarity, preference-based weights, and information amount into a single evaluation value for each section through a weighted summation or another aggregation function.

Output: section objects annotated with evaluation values.

### Step 11:

The server ranks the section objects based on their evaluation values and determines which sections to keep.

Input: section objects with evaluation values.

The server sorts the sections in descending order of evaluation value and applies a selection rule, such as keeping only the top N sections or only sections whose evaluation values exceed a threshold.

The server discards lower-ranked sections and retains a subset that best matches the user's context.

Output: a selected subset of section objects representing the most relevant generated content.

### Step 12:

The server formats the selected sections into structured content suitable for transmission to the terminal.

Input: selected subset of section objects.

The server assembles heading information, body information, and section identifiers into a structured data representation, adds metadata such as generation time, and may compress or simplify the content depending on network conditions.

The server converts the internal representation into a transmission-ready format with explicit fields, while preserving the logical separation between sections.

Output: structured content data prepared for delivery to the terminal.

### Step 13:

The server sends the structured content data to the terminal over the communication network.

Input: structured content data.

The server constructs a response message, sets appropriate headers, and transmits the message using a secure protocol.

The terminal receives the response, verifies the status code, and passes the body to its application logic.

The terminal parses the content and reconstructs heading and body strings for each section.

Output: a set of displayable content elements on the terminal side.

### Step 14:

The terminal displays the structured content to the user using its display device.

Input: parsed structured content elements (headings, bodies, section identifiers).

The terminal arranges headings and bodies in a scrollable view, applies visual formatting such as font size and indentation, and organizes sections according to their indices.

The terminal may show additional controls, such as buttons for feedback or further requests.

The user views the content, scrolls through sections, and optionally selects or highlights specific parts.

Output: visual presentation of personalized, structured content on the terminal screen.

### Step 15:

The user provides additional conditions or evaluation information about the displayed content, and the terminal collects this feedback.

Input: user interactions with feedback controls (ratings, comments, new requests).

The terminal packages the feedback into a message containing identifiers of the evaluated sections, scores or comments, and any new textual requests, and transmits the message to the server.

The server receives the feedback, updates preference information and attribute information in the database, and stores associations between feedback and generated sections.

Output: updated user preference data and a feedback record stored on the server.

### Step 16:

The server uses the updated preference information and feedback to refine subsequent processing.

Input: updated preference information, attribute information, and feedback records.

The server adjusts parameters used in the natural language processing and evaluation phases, such as weights in the evaluation value calculation or rules for selecting processing types.

The server constructs a revised prompt sentence incorporating additional conditions from the user, such as:
“User's experience: project management in software development.
User's goal: manage AI-powered projects in the future.
Additional request: focus on concrete technical implementation steps and reduce general introductions.
Generate three sections with detailed, technical bullet points suitable for an experienced practitioner.
Write in English.”

The server then repeats the generation, structuring, selection, and display steps using the refined configuration, thereby iteratively improving the relevance and usefulness of the content presented to the user.

Output: a new or updated prompt sentence and modified processing parameters for subsequent runs.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional talent recommendation and meeting scheduling systems typically rely on rule-based filtering, static keyword matching, or simple database queries that operate on pre-defined fields. Such approaches require users to manually specify skills, roles, and constraints using rigid input formats, and require system designers to predefine matching logic between user attributes and member attributes. As a result, existing systems are unable to fully leverage unstructured natural language description of user experience, future goals, and free-form prompt sentences, and they often fail to provide highly relevant recommendations or to automatically coordinate meetings at scale.

Furthermore, in many existing systems, a recommendation engine and a scheduling engine operate as separate subsystems, with minimal or no semantic integration. The recommendation logic usually does not consider nuanced meeting conditions or mentoring intentions expressed in natural language, and the scheduling logic does not exploit rich profile similarity scores between users and members. This separation leads to inefficient multi-step workflows in which a user must first manually interpret recommendation results, then separately negotiate and schedule meetings, creating latency, inconsistency, and increased cognitive load for the user.

From a computer technology perspective, conventional architectures do not optimally integrate natural language processing, representation learning, and scheduling computation in a unified processing pipeline. Natural language data such as user experience descriptions, future goal statements, and prompt sentences are either ignored or merely stored as text, rather than being transformed into feature vectors suitable for machine learning models. Consequently, the processor executes redundant or suboptimal data transformations, and cannot systematically reuse shared embeddings and similarity computations across recommendation and scheduling tasks. This results in increased computational overhead, underutilization of available processing resources, and reduced scalability when applied to large organizations.

In addition, existing systems that invoke generative artificial intelligence models typically treat such models as standalone assistants that return unstructured text. Such unstructured responses are then either presented directly to the user or only loosely coupled to downstream processing. The lack of a structured extraction and feedback mechanism prevents the system from systematically converting the semantic content of generative model responses (for example, skill concepts, role concepts, scheduling constraints) into machine-usable conditions. This hinders the ability of the processor to coordinate the recommendation engine and the scheduling engine based on a consistent semantic representation.

Therefore, there is a need for an improved computer-based system and processing method that: (i) converts user experience information, future goal information, and prompt sentences into structured profile data and feature vectors; (ii) integrates such profile data with member profile data in a machine learning model to compute similarity-based recommendations; (iii) uses generative artificial intelligence model responses to automatically extract skill information, role information, and meeting condition information as machine-usable constraints; and (iv) tightly couples recommendation and scheduling operations within a unified processing flow. Such a system should improve the efficiency, scalability, and technical performance of computer-based talent recommendation and meeting scheduling by reducing manual intervention, minimizing redundant computation, and enabling more accurate and context-aware automated processing.

The specific processing by the specific processing unit 290 of the data processing device 12 in Example 2 is realized by the following means.

The present invention provides a server comprising a processor configured to provide, on an information input/output apparatus, an interface for accepting user experience information and future goal information of a user; to obtain the user experience information, the future goal information, and a prompt sentence input by the user; to convert obtained natural language data into feature vectors by using natural language processing technology and embedding generation technology; to generate user profile data based on the feature vectors and store the user profile data in a storage device; to obtain attribute information, work history information, and deliverable information of members belonging to an organization from a data storage device; to convert obtained natural language data regarding the members into feature vectors by using the natural language processing technology and the embedding generation technology; to generate member profile data and store the member profile data in the storage device; to execute a machine learning model using the user profile data and the member profile data as input, to identify members that conform to the user experience information and the future goal information, and to generate a member recommendation list based on a degree of conformity; to generate prompt sentence data for inputting the prompt sentence to a generative artificial intelligence model, to transmit the prompt sentence data to the generative artificial intelligence model and obtain response data, to extract skill information, role information, and meeting condition information from the response data, and to use the skill information, the role information, and the meeting condition information as conditions for member identification processing by the machine learning model and for scheduling processing; to generate meeting schedule information between the user and members selected by the user from candidates included in the member recommendation list via the information input/output apparatus, to obtain availability information of participants through a communication interface of a schedule management system, to calculate a common available time period based on the meeting condition information, to register the meeting schedule information in the schedule management system, and to perform display control to visually present the member recommendation list and the meeting schedule information on the information input/output apparatus. This enables the server to implement an integrated, computer-implemented pipeline in which natural language inputs are transformed into machine-usable feature representations, generative artificial intelligence model responses are structurally exploited as constraints, similarity-based recommendation and calendar scheduling are coordinated within a unified processing flow, and computational resources are utilized more efficiently to provide improved accuracy, scalability, and automation in talent recommendation and meeting scheduling.

The term “processor” refers to a hardware computation unit, such as a central processing unit or a graphics processing unit, and associated control logic that executes program instructions to perform data processing operations described in this specification. The term “information input/output apparatus” refers to any computing apparatus, such as a client terminal or a user device, that includes an input interface and an output interface for allowing a user to input information and to receive and display information from a server. The term “interface” refers to a graphical user interface, command-line interface, or application programming interface provided on the information input/output apparatus for receiving user inputs and presenting outputs related to the system functions.

The term “user experience information” refers to information representing a user's past activities, skills, knowledge, roles, or work history, expressed in natural language or structured form, which is used to characterize the user's background.

The term “future goal information” refers to information representing a user's desired future roles, skills, achievements, or career objectives, expressed in natural language or structured form, which is used to characterize the user's intentions and aspirations.

The term “prompt sentence” refers to a natural language input string provided by the user, which describes desired processing, constraints, or queries, and which is used as a prompt to a generative artificial intelligence model.

The term “natural language data” refers to data expressed in a human language, such as textual sentences or phrases, that are processed by language processing algorithms within the system.

The term “natural language processing technology” refers to algorithms and software components configured to analyze, tokenize, parse, and semantically interpret natural language data, including but not limited to tokenization, part-of-speech tagging, and entity extraction.

The term “embedding generation technology” refers to algorithms and software components configured to convert natural language data or other high-dimensional data into numerical feature vectors that represent semantic or contextual relationships.

The term “feature vector” refers to a numerical representation of one or more properties or characteristics of an entity, such as a user or a member, which is suitable as input to a machine learning model.

The term “user profile data” refers to structured data associated with a user, including at least feature vectors, skill attributes, and goal attributes derived from user experience information, future goal information, and prompt sentences.

The term “storage device” refers to any non-transitory computer-readable medium, such as a magnetic storage, optical storage, or semiconductor memory, used to store data, models, and program instructions.

The term “data storage device” refers to a storage device or storage subsystem configured specifically to store and provide access to attribute information, work history information, and deliverable information of members.

The term “organization” refers to a group of individuals or entities structured to perform activities toward common objectives, such as a company, institution, or department.

The term “member” refers to an individual associated with the organization, such as an employee or contributor, whose attributes and work history can be used for recommendation.

The term “attribute information” refers to information describing static or relatively stable properties of a member, such as role, title, department, or expertise areas.

The term “work history information” refers to information describing past activities or projects performed by a member, including roles, responsibilities, and time periods.

The term “deliverable information” refers to information describing outputs or results produced by a member, such as completed projects, documents, software artifacts, or other work products.

The term “member profile data” refers to structured data associated with a member, including at least feature vectors, skill attributes, and work-related attributes derived from attribute information, work history information, and deliverable information.

The term “machine learning model” refers to a computational model generated by training on data, which is configured to compute relationships, predictions, or similarity scores between inputs such as user profile data and member profile data.

The term “degree of conformity” refers to a quantitative score or measure calculated by the machine learning model or related computation, indicating how well a member matches user experience information, future goal information, and conditions derived from a prompt sentence.

The term “member recommendation list” refers to a data structure that enumerates one or more members identified as candidates, together with associated information such as conformity scores and profile summaries, ordered or filtered according to recommendation criteria.

The term “generative artificial intelligence model” refers to a trained computational model that generates new data, such as text, in response to input prompts, and is capable of producing responses containing semantic content used by the system.

The term “prompt sentence data” refers to a data object or message constructed from a prompt sentence and associated contextual information, formatted for input to a generative artificial intelligence model.

The term “response data” refers to data, such as text or structured output, returned from a generative artificial intelligence model upon processing prompt sentence data.

The term “skill information” refers to information extracted or inferred from response data or other data sources, describing competencies, technologies, or knowledge areas associated with a user or a member.

The term “role information” refers to information extracted or inferred from response data or other data sources, describing functional positions or capacities, such as mentor, project leader, or specialist.

The term “meeting condition information” refers to information extracted or inferred from response data or other data sources that specifies constraints or preferences for meetings, such as duration, time window, type of meeting, or number of participants.

The term “member identification processing” refers to processing operations executed by the processor and the machine learning model to select or rank members based on user profile data, member profile data, and conditions including skill information, role information, and meeting condition information.

The term “scheduling processing” refers to a sequence of operations that determine suitable meeting times and create or update schedule entries based on meeting condition information and availability information.

The term “meeting schedule information” refers to data specifying the scheduling details of a meeting, including at least participant identifiers, date, time, and location or communication link.

The term “schedule management system” refers to a computerized system for managing time-based events and availability, such as a calendar service, which provides an interface for querying availability and registering meeting schedule information.

The term “communication interface of a schedule management system” refers to an application programming interface or protocol endpoint that allows the processor to send requests to and receive responses from a schedule management system.

The term “availability information” refers to data indicating time periods during which participants are available or unavailable for meetings, as obtained from a schedule management system.

The term “common available time period” refers to a time interval or set of intervals during which all relevant participants are simultaneously available according to availability information and meeting condition information.

The term “display control” refers to operations performed by the processor to format, select, and output visual elements on the information input/output apparatus to present information such as the member recommendation list and meeting schedule information.

The term “neural network model” refers to a type of machine learning model comprising interconnected layers of computational nodes, configured to compute outputs, including similarity scores, from input feature vectors.

The term “regression model” refers to a model that computes a continuous value, such as a similarity score or relevance score, from input variables, including feature vectors derived from user profile data and member profile data.

The term “similarity” refers to a numerical value representing a measure of closeness or relatedness between user profile data and member profile data, computed by a neural network model, regression model, or another similarity computation method.

The term “explanation information” refers to information generated by the processor, based on response data from a generative artificial intelligence model or other sources, that describes reasons or factors why particular members are included in the member recommendation list.

In one embodiment, a server, a plurality of terminals, and one or more external schedule management systems cooperatively implement the invention. The server includes at least one processor, a main memory, a non-transitory storage device, and a network interface. The storage device stores program modules, machine learning models, generative AI models or access components thereto, and various data structures including user profile data and member profile data. The terminal includes an input unit, a display unit, a local memory, and a communication unit, and may be realized as a smartphone, a tablet device, a laptop computer, or a desktop computer. The user operates the terminal to interact with the server. The terminal presents a graphical user interface that the server defines by transmitting interface configuration data. The terminal displays input fields for user experience information, future goal information, and at least one prompt sentence. The user enters, for example, “I have 5 years of experience in backend development with Java and Python” as experience information, “I want to lead projects that use generative AI models for business automation” as future goal information, and “Please recommend colleagues who are strong in generative AI model development and schedule a 1:1 meeting this month” as a prompt sentence. The terminal transmits these natural language texts to the server via a secure communication protocol such as HTTPS.

The server stores the raw text data in a data storage device implemented by a relational database system. The server defines explicit data structures such as a user profile table and a member profile table. The user profile table contains fields such as a user identifier, raw experience text, raw future goal text, one or more prompt sentences, and one or more feature vectors. The member profile table contains fields such as a member identifier, attribute information, work history information, deliverable information, and one or more feature vectors. The server also maintains separate tables or key-value stores to hold precomputed embeddings and similarity scores, enabling reuse across sessions and reducing redundant computation.

The server performs natural language processing on the user input texts using specific software components. The server employs tokenization, part-of-speech tagging, sentence segmentation, and named entity recognition implemented in a language processing library. The server converts each sentence or paragraph into a sequence of tokens and then into numeric indices, which are mapped to dense vector embeddings using an embedding generation model. The server may use a transformer-based encoder model to generate fixed-length embedding vectors, for example 768-dimensional or 1024-dimensional vectors, representing the semantic content of the user experience information, the future goal information, and the prompt sentence.

The server also processes organization member data stored in the data storage device. The server retrieves, for each member, attribute information such as role and department, work history information including project titles and time periods, and deliverable information such as project summaries or document descriptions. The server concatenates these fields into normalized text strings and applies the same natural language processing steps to generate member embedding vectors. The server thereby ensures that user embeddings and member embeddings lie in a shared representation space, which improves the numerical stability and accuracy of subsequent similarity computations.

The server configures a machine learning model that uses these feature vectors as input. In one embodiment, the server uses a neural network model comprising an input layer for user vectors and an input layer for member vectors, one or more hidden layers, and an output layer that outputs a similarity or conformity score. The server may configure the neural network as a feed-forward architecture in which user and member vectors are first passed through separate dense layers, then concatenated, and then passed through additional dense layers with nonlinear activation functions such as rectified linear units. The server trains this neural network model offline using supervised or weakly supervised training data that pairs users and members with labels indicating historical success or relevance. The server uses a loss function such as mean squared error loss, logistic loss, or pairwise ranking loss, and updates weights using a gradient descent algorithm or a variant such as Adam. The server may perform regularization by dropout or weight decay to prevent overfitting.

The server uses the trained machine learning model during inference to compute a conformity score between each user profile vector and each member profile vector. The server multiplies matrices of user vectors and member vectors to efficiently compute scores on vector processors or graphics processors, thus significantly reducing latency for large organizations. The server stores these scores or a subset thereof in the storage device or a caching layer for reuse. By using a shared embedding space and batched matrix operations, the server reduces the number of database lookups and the amount of network traffic compared to naïve per-member evaluation, thereby improving processing throughput and scalability.

The server also uses a generative AI model to interpret the prompt sentence in a structured manner. The server constructs an internal prompt message that includes the user's free-form prompt sentence and, optionally, summarized experience and goal information. The server sends this internal prompt to a generative AI model implemented on a remote inference service or as a locally deployed language model. The generative AI model outputs text that encodes skill information, role information, and meeting condition information. The server applies a deterministic parsing procedure or a secondary lightweight classifier to extract discrete entities such as skill labels, role labels, preferred meeting duration, and date constraints from the generative model output.

The server uses the extracted skill information to map from human-readable skill names to canonical identifiers defined in a skill taxonomy stored in the database. The server uses the extracted role information to adjust the type of members that the machine learning model should emphasize, such as mentors, project leaders, or technical specialists. The server uses the extracted meeting condition information to derive machine-usable scheduling constraints, such as “1:1 meeting,” “this month,” or “next week in the afternoon.” This tight coupling between generative AI interpretation and downstream numerical models is not achievable by simple keyword matching, because the generative AI model captures implicit intent and relationships, and the server converts them into explicit constraints used to filter and weight the similarity computation.

The server combines the user profile vectors, member profile vectors, and constraints derived from the generative AI model to compute a member recommendation list. The server modifies input features or model configuration to incorporate the constraints, for example by adding binary or continuous features that indicate required skills or by adjusting loss weights or ranking thresholds. The server then ranks members by the computed conformity scores and prunes members that do not satisfy mandatory constraints derived from the prompt sentence. This produces a more precise and context-aware list than conventional systems that merely filter on static fields.

The server transmits the member recommendation list to the terminal, along with optional explanation information. The explanation information may be generated by combining intermediate model outputs, feature importance measures, or structured fields output by the generative AI model. For example, the server may send an explanation such as “This member is recommended because their profile includes multiple projects with generative AI models and leadership experience in automation initiatives.” The terminal displays the recommendation list and associated explanations, enabling the user to understand why specific members are selected.

The user selects one or more recommended members on the terminal to initiate scheduling.

The terminal sends the identifiers of the selected members and, optionally, additional constraints such as preferred days or time windows back to the server. The server retrieves calendar identifiers for the user and the selected members and interacts with an external schedule management system through an application programming interface. The server requests availability information over a specified time range, receives free/busy slots, and converts them into a time-grid data structure.

The server applies scheduling algorithms to compute a common available time period that satisfies the meeting condition information extracted from the generative AI model. For example, the server may discretize the target time interval into fixed-length slots and label each slot as available or unavailable for each participant. The server then computes the intersection of available slots across all participants and checks which slots accommodate the required duration. The server selects one or more candidate slots based on additional criteria, such as earliest possible time or minimal fragmentation of each participant's schedule. By performing these computations in the server using pre-structured availability data, the system reduces the number of back-and-forth communications that would otherwise be required in a human-managed scheduling process.

The server registers the selected meeting schedule information in the schedule management system via the communication interface. The server then stores the meeting schedule information in its own database, linking it to the user and the involved members. The server returns the confirmed meeting details to the terminal, which displays date and time, participants, and, if applicable, an online conference link.

The combination of embedding-based profile modeling, generative AI interpretation of prompt sentences, and integrated scheduling logic results in several technical effects. The server reduces computational redundancy by using shared representations and batch operations for both recommendation and scheduling constraint evaluation. The server improves accuracy by employing a trained neural network model that captures nonlinear relationships in high-dimensional feature vectors, rather than relying on simplistic rule-based scoring. The server reduces communication overhead by aggregating queries to the schedule management system into fewer batched requests, because the server narrows candidate members before querying availability. The server also decreases storage overhead by storing compact feature vectors instead of duplicating large volumes of unstructured text across subsystems.

In another embodiment, the server uses a regression model instead of or in addition to a neural network model. The server may train a linear or non-linear regression model that predicts a compatibility score between each user-member pair based on features including cosine similarity of embeddings, overlap of skill identifiers, and counts of shared project categories. The server can combine outputs of the regression model and the neural network model through ensemble methods, such as weighted averaging or stacking, to further increase robustness and accuracy.

In a further embodiment, the server varies the generative AI processing flow. The server may use one generative AI model to extract structured constraints and a different model to generate natural language explanations for the recommendations. The server can also cache intermediate generative outputs and parsed constraints so that repeated queries with similar prompt sentences do not require full model invocation, thereby reducing inference latency and external API load.

The server also improves computer technology in terms of data management. By defining explicit schema for user profile data and member profile data, the server enables indexed retrieval and incremental updates. When new experience information or new prompt sentences are provided by the user, the server updates only the relevant embedding vectors and associated rows, without reprocessing the entire database. This incremental update mechanism reduces processing time and improves responsiveness. Additionally, the server can maintain versioned models and embeddings, enabling rollback or comparison of model performance.

The invention can be implemented in different deployment environments. The server may be deployed as a cluster of application servers behind a load balancer. The terminals may be thin clients executing primarily rendering and input logic, while computationally intensive operations such as embedding generation, model execution, and scheduling computation occur on the server side. Alternatively, some embedding generation may be offloaded to powerful terminals if available, reducing network load. The schedule management system may be an external calendar service or an internal enterprise groupware server.

In all these embodiments, the server, the terminal, and the user interact in a way that goes beyond mere automation of human judgment. The server introduces machine-learned representations, generative model-derived constraints, and specialized scheduling algorithms that operate on structured data representations, enabling new computational behaviors that a human alone could not feasibly replicate at scale or speed. This architecture improves processing speed by parallelizing similarity computations, improves recommendation and scheduling accuracy by integrating semantic constraints directly into the model input and filtering logic, reduces communication and storage overhead through shared feature vectors and batched requests, and provides a technically improved computer system for talent recommendation and meeting scheduling based on generative AI model interpretation of prompt sentences.

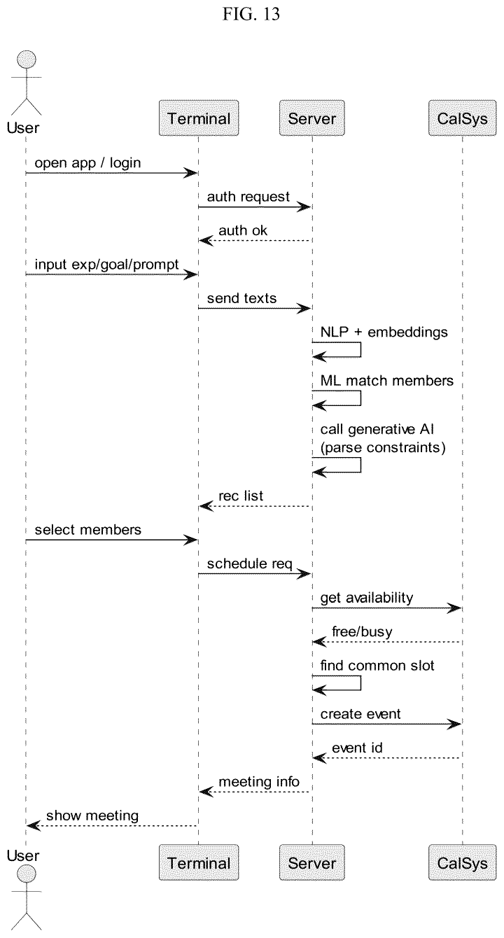

The following describes the processing flow using FIG. 13.

### Step 1:

The user operates the terminal to launch an application and authenticate. The terminal receives user credentials as input and sends them to the server. The server verifies the credentials against stored account data and outputs an authentication token to the terminal. The terminal stores the token and uses it as input for subsequent requests so that the server can perform access control and associate later data with the authenticated user.

### Step 2:

The user operates the terminal to input user experience information, future goal information, and at least one prompt sentence into a graphical user interface. The terminal receives natural language text strings such as “I have 5 years of experience in backend development with Java and Python,” “I want to lead projects that use generative AI models for business automation,” and “Please recommend colleagues who are strong in generative AI model development and schedule a 1:1 meeting this month” as input. The terminal bundles these texts together with the authentication token into a request object, performs basic validation of non-emptiness and character encoding, and outputs a structured request that it transmits to the server via a network connection.

### Step 3:

The server receives the structured request from the terminal as input. The server validates the authentication token and parses the request to extract user experience text, future goal text, and the prompt sentence. The server writes these raw texts into a database as new or updated records in a user input table and outputs database record identifiers that link the raw texts to the user account. The server thereby converts transient network data into persistent storage entries for later processing.

### Step 4:

The server uses the stored raw texts as input to a natural language preprocessing module. The server normalizes whitespace, converts character encodings, and removes control characters from each text string. The server then applies tokenization and sentence segmentation to produce sequences of tokens as intermediate output. Based on these token sequences, the server constructs model-ready inputs, such as integer token IDs and attention masks, and outputs a set of normalized text objects and tokenized representations for subsequent embedding generation.

### Step 5:

The server uses the tokenized user texts as input to an embedding generation component. The server calls a transformer-based encoder or similar model to compute dense feature vectors for the experience text, the future goal text, and the prompt sentence. The server performs matrix multiplications and nonlinear activations to transform discrete token IDs into continuous embeddings and outputs, for each text, a fixed-length feature vector (for example, a 768-dimensional float vector). The server stores these feature vectors in a user profile table and thus converts raw natural language into machine-usable numerical representations.

### Step 6:

The server uses organization member information stored in a data storage device as input. The server retrieves attribute information, work history information, and deliverable information for each member from one or more database tables using database queries. The server concatenates these fields into normalized text strings and applies the same natural language preprocessing and embedding generation steps used for the user texts. The server outputs, for each member, a member profile record including one or more feature vectors that represent the member in the same embedding space as the user.

### Step 7:

The server uses the user feature vectors and the member feature vectors as input to a machine learning model configured for similarity computation. The server feeds the user vectors and each member vector into a neural network model or regression model that combines the vectors, applies learned weights, and computes a conformity score. The server performs these data operations in batches to exploit vectorized computation and outputs, for each member, a numeric score indicating how well the member conforms to the user's experience and future goals. The server stores or caches these scores as part of the member recommendation data.

### Step 8:

The server uses the user's prompt sentence and, optionally, the user experience and future goal summaries as input to a generative AI model interface. The server constructs prompt sentence data that includes instructions for extracting skills, roles, and meeting conditions, embeds the user prompt sentence into this structure, and transmits it to a generative AI model. The generative AI model returns response data as output, such as text describing relevant skills, expected roles, and scheduling constraints. The server parses this response text using pattern matching, parsing rules, or lightweight classifiers to extract discrete skill information, role information, and meeting condition information, and outputs structured constraint objects for downstream use.

### Step 9:

The server uses the conformity scores from the machine learning model together with the structured constraint objects from the generative AI model as input. The server filters out members whose attributes or skills do not satisfy mandatory constraints, such as required skills or specific roles, by comparing extracted skill identifiers and role identifiers with standardized identifiers stored in the database. The server then re-ranks the remaining members by adjusting the conformity scores according to priority factors implied by the prompt sentence, and outputs a member recommendation list containing identifiers, profile summaries, and final ranking scores for the top candidates.

### Step 10:

The server uses the member recommendation list as input to a response formatting module. The server optionally generates explanation information, using intermediate model outputs and constraint matches to produce human-readable reasons for each recommendation. The server then constructs a structured response that includes the ordered list of recommended members and associated explanations and outputs this response to the terminal via the network. The terminal receives the response as input, parses it, and updates the user interface to display the recommendations and explanations to the user.

### Step 11:

The user operates the terminal to inspect the displayed member recommendation list and select one or more members for a meeting. The terminal receives user selections and optional additional constraints, such as preferred dates or times, as input events from the graphical user interface. The terminal aggregates the selected member identifiers and time preferences into a scheduling request and outputs this request to the server together with the authentication token.

### Step 12:

The server receives the scheduling request from the terminal as input. The server retrieves calendar identifiers for the user and the selected members from its database and then sends availability queries to a schedule management system through a communication interface. The schedule management system returns availability information, such as free/busy slots per participant, as output. The server parses this availability information into a standardized time-grid structure and outputs a combined availability representation that shows, for each time slot in a specified range, whether each participant is available or busy.

### Step 13:

The server uses the combined availability representation together with the meeting condition information extracted from the generative AI model as input to a scheduling computation module. The server scans the time-grid structure, identifies contiguous sequences of slots that satisfy the required meeting duration and any time-window constraints (for example, “next week” or “this month”), and computes a set of candidate common available time periods. The server applies selection criteria, such as earliest feasible time or minimal conflicts with existing events, to choose one or more optimal meeting times and outputs finalized meeting schedule information including selected time, duration, and participant list.

### Step 14:

The server uses the finalized meeting schedule information as input to the schedule management system via the communication interface. The server sends a request to create a calendar event, specifying participant identifiers, start and end times, and an optional meeting location or online meeting link. The schedule management system registers the event and returns confirmation data, such as an event identifier, as output. The server stores this meeting schedule information in its own database and outputs a confirmation response containing the meeting details to the terminal.

### Step 15:

The terminal receives the confirmation response from the server as input. The terminal reads the meeting date, time, participants, and any online meeting link from the response and updates the user interface to display the meeting details. The user visually confirms the scheduled meeting on the terminal. The terminal may optionally allow the user to request notifications or modifications, and any such operations generate new inputs that are sent to the server for further data processing and schedule adjustment.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented recommendation and scheduling systems treat natural language understanding, calendar management, and recommendation logic as largely independent functions. As a result, such systems frequently suffer from several technical drawbacks when deployed at scale in computing environments.

First, conventional systems often perform shallow parsing of user input and rely on fixed, rule-based mappings between input text and back-end operations. This approach requires developers to handcraft large sets of rules and intent templates, which are expensive to maintain and do not adapt well to diverse user expressions. When user input deviates from pre-defined patterns, the system either fails to trigger a proper back-end process or triggers an inappropriate one, leading to increased error handling and manual intervention. From a computing perspective, this rigid design constrains how efficiently processor resources can be utilized, because each new use case tends to require additional custom code paths.

Second, known systems typically separate natural language processing modules, recommendation engines, and scheduling components into loosely coupled blocks without a unified control layer. In many architectures, the natural language module produces intermediate labels or intents, which are then consumed by a recommendation engine or a calendar module that has limited context about the original user intent or emotional state.

This fragmented processing pipeline causes redundant memory transfers and repeated computations, because similar user data (e.g., experience, goals, context) must be re-encoded or re-normalized at each stage. It also makes it difficult to coordinate multiple back-end processes-such as person recommendation, worker assignment, and schedule setting-within a single session, increasing latency and reducing throughput.

Third, typical systems incorporate either internal models (such as statistical or machine-learning-based recommenders) or external generative AI models, but not an integrated combination of both. In cases where generative AI models are used, they are often invoked with ad hoc, unstructured prompts, which leads to inconsistent output formats and significant post-processing overhead. This inconsistency forces the system to perform complex, error-prone parsing of AI outputs, wasting processor cycles and memory, and making it difficult to guarantee deterministic behavior for downstream scheduling and recommendation logic.

Fourth, many systems do not systematically incorporate emotion analysis into the computational pipeline that controls recommendation and scheduling. If emotional cues are considered at all, they are typically handled in an ad hoc manner, outside of the core recommendation and scheduling algorithms. As a consequence, the system cannot optimize data flows and scheduling computations based on an explicit emotion state variable, and cannot use that variable as part of a unified input to both internal models and external generative AI models. This leads to underutilization of available contextual signals and forces separate modules to re-analyze the same user text multiple times.

Fifth, conventional systems that create appointments based on calendar APIs generally treat generative AI, calendar services, and user interaction logic as independent services orchestrated at the application layer. Each layer often maintains its own representation of candidate time slots, user preferences, and constraints. This duplication results in redundant data structures in memory, complex synchronization logic, and increased risk of inconsistency in schedule decisions, especially in multi-user or high-concurrency environments.

Accordingly, there is a need for an improved computer-implemented system that integrates natural language processing, emotion analysis, internal inference models, generative AI models, and schedule management into a unified control flow executed by a processor. Such a system should (i) generate structured, purpose-specific prompt sentences that directly instruct a generative AI model to perform well-defined computational tasks, (ii) combine the AI model's responses with internal statistical or machine-learning inference results, and (iii) use both the combined inference and an explicit emotion state to drive person recommendation, worker assignment, and schedule determination. By doing so, the system can reduce redundant computations, minimize parsing and re-encoding overhead, improve the consistency and predictability of AI outputs, and enhance overall utilization of processor and memory resources in recommendation and scheduling operations.

The specific processing by the specific processing unit 290 of the data processing device 12 in Application Example 2 is realized by the following means.

The present invention provides a server comprising a processor and at least one storage device, the processor being configured to provide a user interface for receiving, via a user input/output unit, natural language input including at least user experience, future goals, and schedule-related requests; to perform information analysis processing on the natural language input by executing language analysis processing and emotion analysis processing to extract structured user profile data and an explicit user emotion state; to access, from the storage device, attribute information of members belonging to an organization, operation status information of the members, and progress status information of tasks; to generate, on the basis of the extracted user profile data, the user emotion state, the attribute information of the members, and the progress status information of the tasks, a structured prompt sentence that explicitly instructs a generative AI model to execute at least one of a person recommendation process, a task worker recommendation process, and a schedule setting process; to transmit the structured prompt sentence to the generative AI model through a programmatic interface and to obtain response information from the generative AI model in a predefined format; to construct and maintain, by using the natural language input data, the attribute information of the members, and the progress status information of the tasks as learning data, an internal inference model that executes the person recommendation process or the task worker recommendation process according to a statistical or machine-learning method; to determine a recommendation result by integrating an inference result of the internal inference model with the response information from the generative AI model, thereby reducing reliance on any single model; to acquire, via a schedule management function, schedule information of the user and of a recommended member and to compute candidate time periods in which both are available; to generate a further prompt sentence instructing the generative AI model to evaluate the candidate time periods on the basis of schedule-related expressions extracted from the natural language input and the user emotion state, and to select, based on an evaluation result from the generative AI model, a schedule time that reduces psychological load of the user; to automatically register, through an external schedule management service, a schedule between the user and the recommended member at the selected schedule time; and to generate advice information relating to at least one of career development, person selection, task assignment, and product selection for the user, based on the response information from the generative AI model, and to cause the advice information to be visually presented through the user input/output unit. This enables unification and optimization of natural language understanding, emotion-aware recommendation, and schedule computation within a single server-side control flow, reduces redundant parsing and model invocations, stabilizes the interaction with the generative AI model through structured prompt sentences and predefined response formats, improves utilization of processor and memory resources by integrating internal inference models with external generative AI responses, and provides more accurate and context-aware person recommendations, worker assignments, and appointment schedules in a computer-implemented environment.

The term “user interface” refers to a logical and physical presentation layer implemented by a computing device that enables a user to input information and receive output, including but not limited to graphical, textual, or audio elements rendered on a display or speaker and controlled by input devices such as a keyboard, pointing device, touch panel, or microphone.

The term “user input/output unit” refers to a hardware and software combination that handles acquisition of user input and presentation of output, including at least a display device, an input device, and associated control logic executed by a processor.

The term “natural language input” refers to text or speech content expressed in a human language and provided by a user to the system without requiring the user to follow a predefined command syntax or structured data format.

The term “user experience” refers to information describing activities, roles, skills, or achievements that a user has acquired in the past, including but not limited to work history, projects, education, or training.

The term “future goals” refers to information describing objectives, targets, or desired states that a user intends to achieve in the future, including but not limited to career goals, learning goals, or project goals.

The term “schedule-related requests” refers to natural language expressions indicating a desire to create, change, or cancel an appointment or event at a particular date, time, or time range.

The term “information analysis processing” refers to a sequence of computational operations executed by a processor that transform raw natural language input into structured data, including at least language analysis processing and emotion analysis processing.

The term “language analysis processing” refers to processing that interprets natural language text or speech by applying techniques such as tokenization, part-of-speech tagging, syntactic parsing, entity extraction, or semantic analysis.

The term “emotion analysis processing” refers to processing that estimates an emotional state of a user from input data by applying techniques such as sentiment analysis, affective computing, or emotion classification based on textual, audio, or other signals.

The term “user emotion state” refers to an internal representation of an emotional condition of a user, such as stress level, motivation level, or valence, obtained from emotion analysis processing and encoded as one or more labels, scores, or vectors.

The term “storage device” refers to any non-transitory computer-readable medium capable of storing digital information, including but not limited to semiconductor memory, magnetic storage, or optical storage.

The term “attribute information of members” refers to structured data describing characteristics of persons belonging to an organization, including but not limited to roles, skills, experience level, and relationships.

The term “operation status information” refers to data that represent current or recent activity of members, including but not limited to availability, workload, assignment status, or participation in tasks.

The term “progress status information of tasks” refers to data representing the advancement or delay of tasks or processes, including but not limited to start times, completion times, step status, and performance indicators.

The term “prompt sentence” refers to a textual instruction generated by the processor for submission to a generative AI model, the instruction specifying a computational task to be performed and optionally defining constraints and output formats.

The term “generative AI model” refers to a machine-learned model configured to generate natural language or structured outputs in response to input prompts, including but not limited to models based on neural network architectures.

The term “response information” refers to data returned from a generative AI model in reply to a prompt sentence, the data including at least natural language text or structured output to be used by the system.

The term “person recommendation process” refers to a computational process that identifies and ranks one or more members suitable for interaction with a user, on the basis of user-related data and member-related data.

The term “task worker recommendation process” refers to a computational process that identifies and ranks one or more members suitable to perform a specific task, on the basis of task-related requirements and member-related capabilities.

The term “schedule setting process” refers to a computational process that determines one or more times for an appointment or event among participants, on the basis of schedule information, constraints, and preferences.

The term “person recommendation function” refers to functionality of the processor configured to output at least one recommended member or task worker to a user based on data including response information from a generative AI model and attribute information of members.

The term “schedule setting function” refers to functionality of the processor configured to acquire schedule information of participants, compute available time periods, and determine an appointment time.

The term “schedule management function” refers to a logical component, which may include an external calendar service, that manages creation, modification, retrieval, and deletion of schedule entries for users and members.

The term “advice information” refers to output data containing guidance, suggestions, or recommendations for a user regarding at least one of career development, person selection, task assignment, or product selection.

The term “advice information presenting function” refers to functionality of the processor configured to generate advice information from response information and to cause the advice information to be displayed or otherwise presented to a user.

The term “internal inference model” refers to a computational model implemented within the system that infers recommendation results or other outputs based on input data, using statistical or machine learning techniques.

The term “statistical information processing method” refers to a method that derives parameters or predictions from data using statistical techniques such as regression analysis, clustering, or probabilistic modeling.

The term “machine learning method” refers to a method that trains a parameterized model on example data to perform tasks such as classification, regression, or ranking, including supervised, unsupervised, or reinforcement learning.

The term “integrated inference function” refers to functionality of the processor configured to combine an inference result from an internal inference model with response information from a generative AI model to determine a final recommendation result.

The term “candidate time periods” refers to a set of time intervals during which participants are tentatively available for scheduling an appointment or event, as derived from schedule information or computed constraints.

The term “emotion-adaptive schedule determination function” refers to functionality of the processor configured to determine a schedule time based on an evaluation of candidate time periods that takes into account a user emotion state.

The term “evaluation result” refers to data generated by a generative AI model or internal model that indicate a relative suitability or ranking of candidate time periods or options.

The term “psychological load of the user” refers to an estimated degree of mental burden or stress associated with a schedule time or interaction, derived from the user emotion state and contextual information.

The term “organization” refers to an entity composed of multiple members, such as a group, department, or enterprise, for which tasks, roles, and schedules are managed by the system.

The term “member” refers to an individual associated with an organization, including but not limited to an employee, contractor, or collaborator who can be recommended or scheduled by the system.

The term “task” refers to a unit of work or activity to be performed by one or more members, including but not limited to an operation, project step, or service action.

The term “schedule information” refers to data representing existing and planned appointments, events, or time blocks associated with one or more users or members.

The term “external schedule management service” refers to a remote or separate system that provides an application programming interface for storing, retrieving, and managing calendar or schedule entries.

The term “user profile data” refers to structured information describing a user's characteristics, including but not limited to experience, goals, preferences, and historical interactions with the system.

In one embodiment, a server, one or more terminals, and one or more storage devices together constitute a system that implements the claimed invention. The server executes computer programs on one or more processors, such as central processing units and optionally graphics processing units. The server accesses a main memory and non-transitory storage devices, such as a relational database and a file storage system. The terminals include computing devices such as notebook computers, desktop computers, tablet computers, or smart phones, each equipped with at least a display device, an input device, a network interface, and a local processor.

The server provides a user interface through which a user operates a terminal to input natural language information. The terminal renders the user interface by executing a web browser or a native application. The server outputs user interface data using web technologies such as a markup language and a scripting language, or a platform-specific user interface toolkit. The terminal displays text boxes, selection controls, and buttons and captures user input via keyboard, pointing device, touch panel, or microphone.

The user operates the terminal to input free-form text describing the user's experience, future goals, and schedule-related requests. The user may, for example, input the following sentences:
“I have project management experience and I want to work on AI-driven project management.” “I want to schedule a 1on1 appointment next Monday.” “Recently
I am interested in fitness and looking for fitness-related gadgets.”

The terminal transmits this text to the server over a network using a secure communication protocol. The server receives the text as part of a structured request and stores the raw text and associated metadata, such as a user identifier and a timestamp, in a relational database system such as a general-purpose relational database engine.

The server analyzes the natural language input by executing language analysis processing and emotion analysis processing. The server performs the language analysis processing using a natural language processing library, such as a statistical or neural language processing library implemented in a high-level language. The server tokenizes the text into tokens, assigns part-of-speech tags, performs dependency parsing, and extracts named entities such as roles, dates, organizations, product categories, and skill names. The server further applies rule-based pattern matching or trained sequence labeling models to detect schedule-related expressions, goal-related expressions, and experience-related expressions.

The server performs the emotion analysis processing using a sentiment or emotion classification model. In one implementation, the server deploys a neural network model that maps sequences of word embeddings to an emotion label and a continuous sentiment score. The server may use a bidirectional recurrent neural network or a transformer-based encoder. The server encodes each token using a pre-trained embedding table or a subword encoder, applies multiple layers of self-attention or recurrent computation, aggregates the sequence representation, and feeds the aggregated representation into a fully-connected layer followed by a softmax activation to output probabilities over emotion categories, such as “highly motivated”, “stressed”, “neutral”, or “discouraged”. During training, the server minimizes a cross-entropy loss between predicted probabilities and ground truth emotion labels and updates model weights using a gradient-based optimization algorithm. The server can also fine-tune pre-trained language representations on domain-specific emotion-labeled data.

The server stores the output of the language analysis and the emotion analysis as structured user profile data in the database. The server maintains normalized tables for user experience entries, future goal entries, schedule preference entries, and emotion state entries. Each entry references the user identifier and includes a structured representation such as a role type, skill category, desired time range, and emotion label. By converting free-form text into structured data, the server reduces redundancy and simplifies access patterns in later computations.

The server also accesses stored attribute information of members belonging to an organization. The server maintains a member table in the relational database, where each member has fields such as role type, skill vectors, historical performance indicators, and schedule preferences. The server periodically updates this table by analyzing artifacts such as project records, task logs, and performance metrics. For this analysis, the server can execute an internal machine learning model. In one example, the server uses a feed-forward neural network that takes as input features describing a member's past tasks, success rates, completion times, and skill annotations, and outputs a latent feature vector representing the member's capabilities. The server trains this model using backpropagation with a mean squared error loss or a ranking loss on historical assignment and outcome data.

The server further maintains progress status information of tasks. The server receives task updates from external systems, such as production control systems, workflow engines, or factory controllers. In a production environment, the server receives time-series sensor data from equipment. The server stores these signals in a time-series database and periodically aggregates them into task-level progress descriptors, such as estimated completion percentage and delay flags. The server associates each task with required skill categories and with specific process steps.

The server generates a prompt sentence for a generative AI model based on the structured user profile data, the user emotion state, the member attribute information, and the task progress information. The server uses prompt templates that explicitly define the computational task for the generative AI model and the expected output format. The server does not simply forward raw user text; instead, the server synthesizes a prompt sentence that concisely encodes the relevant structured data and instructs the generative AI model to produce a machine-usable response.

The server, for example, can generate the following prompt sentence for career-development advice:
“The user wrote: ‘I have project management experience and I want to work on AI-driven project management.’ Analyze the user's background and motivation, then propose a concrete step-by-step plan for the next 6 months.”

The server can generate the following prompt sentence for worker recommendation in a production environment:
“In the assembly process of product X, installation of part Y is delayed. From the worker performance data below, recommend the best worker for part Y installation and explain why. Data: [worker statistics in textual form].”

The server can generate the following prompt sentence for appointment parsing:
“From the following text, extract the desired appointment date, time, and meeting type as JSON-like key-value pairs. Text: ‘I want to schedule a 1on1 appointment next Monday.’ Output fields: date, time_window_start, time_window_end, meeting_type.”

The server can generate the following prompt sentence for emotion-adaptive schedule determination:
“The user's emotional state is ‘stressed’. From the candidate time slots below, choose one that minimizes psychological burden and justify briefly. Slots: [list of time ranges in textual form].”

In addition, the server can generate a prompt sentence for product recommendation:

“The user wrote: ‘Recently I am interested in fitness and looking for fitness-related gadgets.’ Recommend three concrete products that fit this interest and may increase purchase intent, and explain why.”

The server transmits the prompt sentence to a generative AI model via an application programming interface. The server selects a model type that supports natural language generation and structured response. The generative AI model can be implemented as a large-scale neural network, such as a transformer-based language model, with multiple attention layers, feed-forward sublayers, and layer normalization. The server configures the model using a set of parameters such as maximum output length, temperature, and top-k or top-p sampling thresholds. The server uses a stateless request-response protocol so that each prompt and response pair can be processed independently.

The server receives response information from the generative AI model. The response can take the form of natural language text or structured text that follows the constraints described in the prompt sentence. The server parses the response using deterministic rules or a lightweight parser. For example, if the response encodes a list of recommended members or schedule options, the server extracts identifiers, time ranges, or ranking scores from the response and maps them back to internal identifiers stored in the relational database.

The server also constructs and maintains an internal inference model to perform person recommendation and task worker recommendation. The server trains this internal model on historical data stored in the database. This internal model can be a gradient-boosted decision tree model, a neural ranking model, or a factorization machine, which takes as input feature vectors representing user profile data, member attributes, and task descriptors. The internal model outputs predicted suitability scores for each candidate member. The server uses a loss function such as pairwise ranking loss or cross-entropy loss on labeled historical assignments and updates model parameters using an optimization algorithm.

The server integrates the output of the internal inference model with the response information from the generative AI model. The server, for instance, can normalize scores from both sources to a common scale and compute a weighted sum, or can use a meta-model that learns to combine the two sets of scores. The server stores combination weights or meta-model parameters in the storage device. By combining outputs from a discriminative internal model and a generative AI model, the server improves robustness and accuracy of recommendations and reduces over-reliance on free-form generative outputs.

The server thereby determines a final recommendation result, such as a ranked list of members suitable to mentor the user, a ranked list of task workers suitable to handle a delayed manufacturing step, or a ranked list of products relevant to the user's interests. The server stores the final recommendation result in the database and transmits it to the relevant terminal as structured data. The terminal renders the recommendation as a list or grid, showing the member names, roles, main skills, or product descriptions, possibly accompanied by short explanations generated from the generative AI model.

The server also interacts with a schedule management function, which may be provided by an external calendar service. The server acquires schedule information of the user and of a recommended member by calling a calendar application programming interface using authenticated tokens. The server retrieves existing events and free/busy data for a given date range. The server computes candidate time periods by intersecting free time segments of the user and of the recommended member and by considering minimum meeting duration and any constraints derived from the user profile.

The server then generates another prompt sentence for the generative AI model to evaluate candidate time periods in light of the user's emotion state and textual schedule preferences. The server can, for example, include in the prompt a table of candidate time slots and labels describing time-of-day characteristics. The generative AI model returns an evaluation, such as a preference ordering or a natural-language justification. The server interprets this evaluation and selects a single schedule time that is predicted to reduce psychological load or increase user comfort. In alternative embodiments, the server can avoid using the generative AI model for time-slot evaluation and rely entirely on a heuristic or learned scoring function that directly uses the emotion state and historical behavior of the user.

The server automatically registers the selected schedule time by creating an event in the external calendar system via the schedule management function. The server sets event fields such as start time, end time, participants, and description. The server writes an appointment record in the local database, containing a reference to the external calendar event identifier. The terminal displays a confirmation to the user. The user can accept, modify, or cancel the appointment using the user interface, and the server propagates changes back to the calendar system.

The server further generates advice information for the user by post-processing the response information from the generative AI model. The server formats the advice into structured sections, such as “short-term actions”, “recommended skills to learn”, or “people to talk to”. The terminal presents these sections as visual components. The user can select recommended actions, view details, or trigger further requests to refine goals. This interaction yields new data that the server uses to update the user profile and retrain internal models.

The system architecture in this embodiment achieves technical improvements beyond merely automating human decision-making. The server reduces redundant data conversions and repeated analysis by storing intermediate results of language analysis and emotion analysis in normalized database tables. The server uses structured prompt sentences, rather than arbitrary free-form prompts, to stabilize and constrain interactions with the generative AI model. This reduces the need for complex, error-prone parsing of generative outputs and decreases processor time spent on correcting or re-interpreting inconsistent responses. Moreover, by integrating the internal inference model with the generative AI model, the server leverages fast numerical inference executed locally to filter and pre-rank candidates, and uses the generative AI model primarily for high-level reasoning and explanation. This combination reduces the number of generative AI model calls and thereby reduces latency, network load, and external computation costs.

The server also optimizes storage access patterns by pre-computing and caching member feature vectors and task descriptors. When a recommendation or scheduling request arrives, the server retrieves compact feature vectors rather than raw logs or documents, which decreases main memory usage and disk I/O. The server further benefits from the explicit user emotion state, which serves as an additional dimension in feature space and allows models to more precisely discriminate between situations requiring different scheduling or recommendation behavior. This leads to improved prediction accuracy and fewer incorrect assignments or unsuitable appointments.

In another embodiment, the server deploys the internal inference model as a deep learning model such as a multi-layer perceptron with several hidden layers. The server concatenates embeddings of the user profile, the candidate member, and the task descriptor to form the input vector. The server trains this model with mini-batch gradient descent and a regularization term to avoid overfitting. The server can apply data augmentation techniques by synthetically generating small variations of user goals and tasks, thereby making the model more robust to novel inputs. The system in this embodiment further includes monitoring routines that track the distribution of model inputs and prediction errors over time, enabling adaptive adjustment of learning rates and model retraining schedules.

In a variant embodiment, the server executes the generative AI model locally rather than via a remote service. The server stores the model weights on a storage device and loads them into memory. The server uses a numerical computation library to perform matrix multiplications, attention computations, and non-linear activations. The server can use hardware acceleration via a graphics processing unit or a specialized accelerator. This variant reduces dependence on external services and network latency but may require greater local hardware resources. In yet another embodiment, the terminals include industrial operator panels connected to manufacturing equipment. The server receives machine sensor data, analyzes task delays, and recommends task workers as described above. The server transmits recommendations and schedule assignments back to the operator panels, which display instructions to operators and optionally adjust machine configuration settings within allowed limits. For example, the server can set a machine to maintenance mode during a delayed step until a recommended specialist is assigned. By doing so, the system is linked directly to control of physical equipment and contributes to reduced downtime and improved throughput.

Because the server coordinates language analysis, emotion analysis, internal inference, generative AI invocations, and schedule registration through a designed data flow and modular structure, the system improves computing efficiency and reliability. Data structures are defined to avoid duplication; prompt sentences are structured to constrain generative behavior; and inference combination methods are designed to exploit the complementary strengths of deterministic internal models and flexible generative models. These aspects collectively provide technical effects such as faster overall response time under high load, improved prediction accuracy in recommendations and schedule choices, reduced network traffic for model invocations, and reduced memory footprint due to compact feature representations and normalized storage.

The user, by operating the terminal, experiences these improvements as more accurate and context-aware recommendations and schedules; however, the primary advancement lies in the improved way the server processes, stores, and communicates data between modules and models. The server thereby implements a specific, non-conventional arrangement of language processing, model invocation, model integration, and calendar interaction that improves the functioning of the computer system itself.

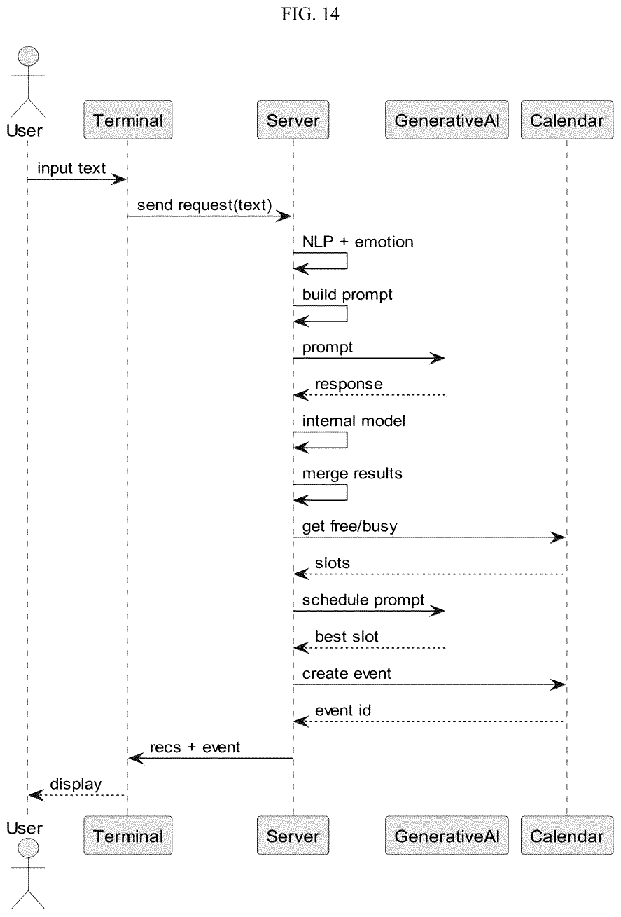

The following describes the processing flow using FIG. 14.

### Step 1:

User operates the terminal to open an application and input natural language text.

User uses a web browser or native application on the terminal to access a user interface provided by the server.

User inputs free-form text describing experience, future goals, and schedule-related requests, for example, “I have project management experience and I want to work on AI-driven project management,” or “I want to schedule a 1on1 appointment next Monday.”

Input: Raw natural language text typed or spoken by the user, together with implicit context such as the current screen and interaction type.

Output: User input data held in the terminal's memory, including the text string and basic metadata such as time of input.

### Step 2:

Terminal transmits structured request data to the server.

Terminal converts the captured text and metadata into a structured request object, such as a JSON-like key-value representation including fields for user identifier, session identifier, input text, and timestamp.

Terminal sends this request over a network to the server using a secure communication protocol.

Input: In-memory user input data consisting of the text and metadata.

Output: Network message containing a structured request delivered to the server.

### Step 3:

Server receives the request and stores raw input in persistent storage.

Server accepts the network message through a communication module and deserializes the structured request object.

Server validates required fields and then writes the raw text, user identifier, and timestamp into a relational database table for user inputs.

Server assigns a unique request identifier and stores it with the record.

Input: Structured request object containing text, user ID, and timestamp.

Output: Database record in a user input table, including a newly generated request ID.

### Step 4:

Server performs language analysis processing on the input text.

Server retrieves the text associated with the request ID from the database and passes it to a natural language processing module.

Server tokenizes the text, assigns part-of-speech tags, performs syntactic parsing, and extracts named entities such as roles, skills, dates, and product categories.

Server also applies pattern-based or model-based classification to identify expressions that correspond to experience, goals, and schedule intentions.

Input: Raw text from the user and the associated request ID.

Output: Structured language analysis result that includes token lists, entity lists, identified intent types, and extracted phrases.

### Step 5:

Server performs emotion analysis processing to estimate the user emotion state.

Server applies an emotion classification model, such as a neural network that maps word sequences to an emotion label and a sentiment score, to the text or to features derived in the language analysis.

Server encodes the text into numerical vectors, runs the model, and computes probabilities for emotion categories such as “highly motivated” or “stressed.”

Server selects the most probable label and the corresponding score and stores these values in an emotion table linked to the request ID.

Input: User text and language analysis features associated with the request.

Output: Emotion state record containing an emotion label and one or more numerical scores.

### Step 6:

Server constructs or updates structured user profile data.

Server combines the extracted experience phrases, goal phrases, and schedule-related phrases with existing profile records for the user.

Server normalizes roles and skills into predefined categories and merges new data with previous entries, updating counts or timestamps as needed.

Server writes the resulting profile data into user profile tables, including fields such as role type, skill category, target role, and preferred schedule windows.

Input: Language analysis result, emotion state, and existing profile records for the user.

Output: Updated structured user profile data stored in the database.

### Step 7:

Server retrieves member attribute information and task progress information.

Server queries member tables to obtain attributes such as role types, skills, latent feature vectors, and current availability of organization members.

Server queries task tables or task progress tables to obtain information about ongoing tasks, including required skills and whether any steps are delayed.

Input: Request ID, user profile data, and database tables containing member and task information.

Output: Structured datasets of candidate members and relevant tasks, each represented as feature vectors and attribute lists.

### Step 8:

Server prepares feature vectors for internal inference.

Server transforms user profile data, member attributes, and task descriptors into numerical feature vectors suitable for computation by an internal inference model.

Server performs operations such as one-hot encoding, embedding lookup, and normalization to map categorical and numerical fields into a common vector space.

Server aggregates the vectors for each user-member or task-member pair that may be recommended.

Input: Structured user profile data, member attributes, and task descriptors.

Output: Collections of numerical feature vectors representing candidate pairs for recommendation.

### Step 9:

Server executes an internal inference model to compute preliminary recommendation scores.

Server feeds each feature vector into the internal model, such as a deep neural network or a gradient-boosted decision tree model, to compute suitability scores.

Server processes multiple candidate vectors in batches to exploit vectorized computation and hardware parallelism.

Server stores the scores in memory or in a temporary database table associated with candidate identifiers.

Input: Feature vectors describing candidate user-member or task-member combinations.

Output: Preliminary recommendation scores for each candidate combination.

### Step 10:

Server generates a prompt sentence for the generative AI model based on structured data.

Server selects a prompt template according to the identified intent type, such as career advice, worker assignment, or appointment setting.

Server fills the template with user profile summaries, candidate member summaries, task progress summaries, and emotion state descriptions.

Server, for example, generates one of the following prompt sentences:
“The user wrote: ‘I have project management experience and I want to work on AI-driven project management.’ Analyze the user's background and motivation, then propose a concrete step-by-step plan for the next 6 months.”
“In the assembly process of product X, installation of part Y is delayed. From the worker performance data below, recommend the best worker for part Y installation and explain why. Data: [worker statistics in textual form].”
“From the following text, extract the desired appointment date, time, and meeting type as JSON-like key-value pairs. Text: ‘I want to schedule a 1on1 appointment next Monday.’ Output fields: date, time_window_start, time_window_end, meeting_type.”
“The user's emotional state is ‘stressed’. From the candidate time slots below, choose one that minimizes psychological burden and justify briefly. Slots: [list of time ranges in textual form].”

Input: Structured user profile data, candidate member and task summaries, and emotion state. Output: Prompt sentence text prepared for submission to the generative AI model.

### Step 11:

Server transmits the prompt sentence to the generative AI model and obtains response information.

Server constructs a request payload including the prompt sentence and configuration parameters such as maximum output length and sampling settings.

Server sends the payload to the generative AI model through an application programming interface and waits for a response.

Server receives the generated text response, verifies that it satisfies basic format constraints, and records the prompt and response in a log table for traceability.

Input: Prompt sentence and model configuration parameters.

Output: Response information from the generative AI model in text form.

### Step 12:

Server parses the response information into structured results.

Server applies pattern matching, simple parsers, or additional lightweight models to convert the generative output into structured objects.

Server extracts entities such as recommended member identifiers, ordered lists, schedule times, or action suggestions from the response text.

Server checks for missing or inconsistent fields and, if necessary, applies fallback rules to repair or complete the structured result.

Input: Raw text response from the generative AI model.

Output: Structured response objects representing recommendations, schedule decisions, or advice items.

### Step 13:

Server integrates internal model scores with generative AI recommendations.

Server aligns candidate identifiers in the structured response objects with those in the internal model's scoring table.

Server normalizes or rescales the internal scores and any scores or rankings implied by the generative output.

Server combines these values using a predefined combination rule, such as a weighted sum or learned meta-model, to produce final scores and rankings.

Input: Preliminary internal model scores and structured generative AI recommendations.

Output: Final recommendation ranking or final selection for members, workers, or options.

### Step 14:

Server selects recommended persons or workers and stores the result.

Server chooses top-ranked candidates according to the integrated scores, possibly applying additional constraints such as availability or maximum load per member.

Server writes the selected candidates and their scores into a recommendation result table linked to the request ID.

Server prepares a response payload for the terminal, including display names, roles, skills, and explanation text if available.

Input: Final scores and rankings from the integration step.

Output: Final recommendation list stored in the database and prepared for transmission to the terminal.

### Step 15:

Server determines whether schedule processing is required.

Server examines the intent type and the structured results to check whether the user requested scheduling or appointment setting.

Server branches into scheduling logic when schedule-related input or response fields are present, such as desired date, time window, or meeting type.

Input: Intent classification result and structured response objects.

Output: Decision flag indicating whether to perform schedule computation.

### Step 16:

Server retrieves schedule information for the user and recommended members.

Server calls a schedule management function, such as a calendar service, using authorization credentials associated with the user and the recommended member.

Server obtains existing events and free/busy data over a relevant date range and converts them into internal free-time intervals.

Input: User and member identifiers and a scheduling horizon.

Output: Free-time interval lists for each participant.

### Step 17:

Server computes candidate time periods for an appointment.

Server computes intersections of the free-time intervals of the user and the recommended member and filters intervals shorter than a required minimum duration.

Server attaches attributes to each candidate period, such as time-of-day category and day-of-week.

Input: Free-time interval lists for participants and meeting duration requirements.

Output: A set of candidate time periods annotated with attributes.

### Step 18:

Server generates a schedule-evaluation prompt sentence and obtains evaluation from the generative AI model.

Server incorporates the candidate time periods and the user emotion state into a new prompt sentence that instructs the generative AI model to evaluate which time period is most suitable.

Server sends the prompt sentence to the generative AI model and receives an output that ranks the time periods or selects one and provides a justification.

Input: Candidate time periods and user emotion state.

Output: Generative AI evaluation indicating a recommended time period.

### Step 19:

Server selects a final schedule time and registers the appointment.

Server maps the recommended time period back to a precise start and end time and double-checks that no new conflicts have arisen.

Server calls the schedule management function to create a new calendar event for the user and the recommended member at the selected time, including descriptive fields obtained from the response information.

Server stores appointment details in an appointment table, including references to external calendar event identifiers.

Input: Evaluation result from the generative AI model and current free-time data.

Output: Confirmed appointment record in external and internal schedule storage.

### Step 20:

Server generates advice information and formats it for presentation.

Server uses response information from the generative AI model, such as step-by-step career plans or product suggestions, and organizes this content into structured sections.

Server creates a response payload that includes textual advice and, where relevant, links or identifiers for recommended persons, tasks, or products.

Input: Structured response objects for advice and recommendations.

Output: Formatted advice data ready for display on the terminal.

### Step 21:

Terminal receives recommendation, schedule, and advice data and presents them to the user.

Terminal deserializes the response payload from the server and renders graphical components such as lists, cards, or dialogs.

Terminal displays recommended persons or workers, confirmed appointment details, and advice messages, and provides controls for the user to accept, refine, or reject the outputs.

Input: Response payload containing recommendations, appointment data, and advice information.

Output: Visual output presented to the user and new potential user actions captured by the terminal.

### Step 22:

User interacts with the outputs and provides follow-up input.

User views recommendations and appointment details and may accept an appointment, request changes, or initiate further questions, such as refining goals or asking for alternative timings.

User inputs follow-up text such as “Please suggest a different time in the afternoon” or “Show more mentors with AI experience.”

Input: Displayed outputs and user decisions.

Output: New user input events that the terminal forwards to the server for subsequent processing, thereby restarting or continuing the processing flow.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

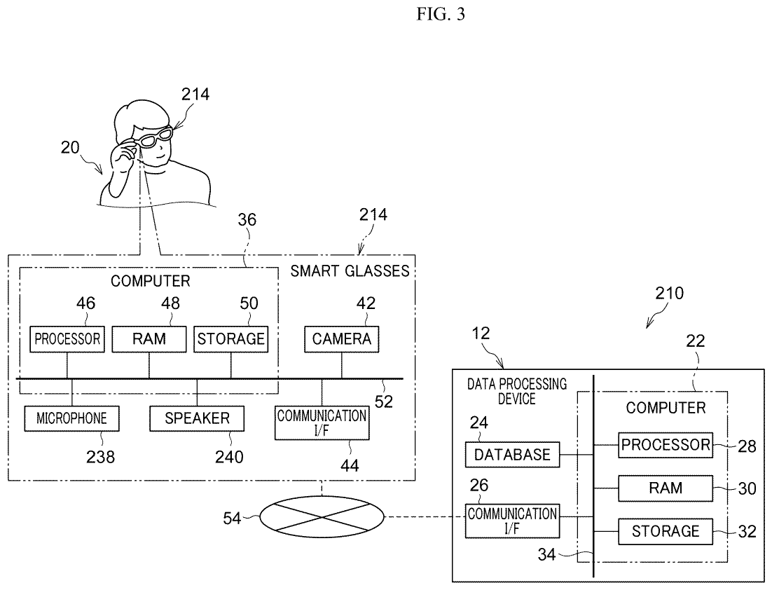

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

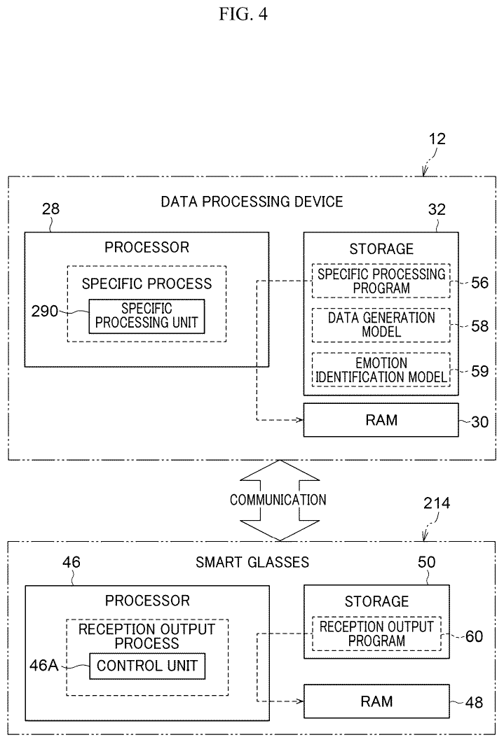

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

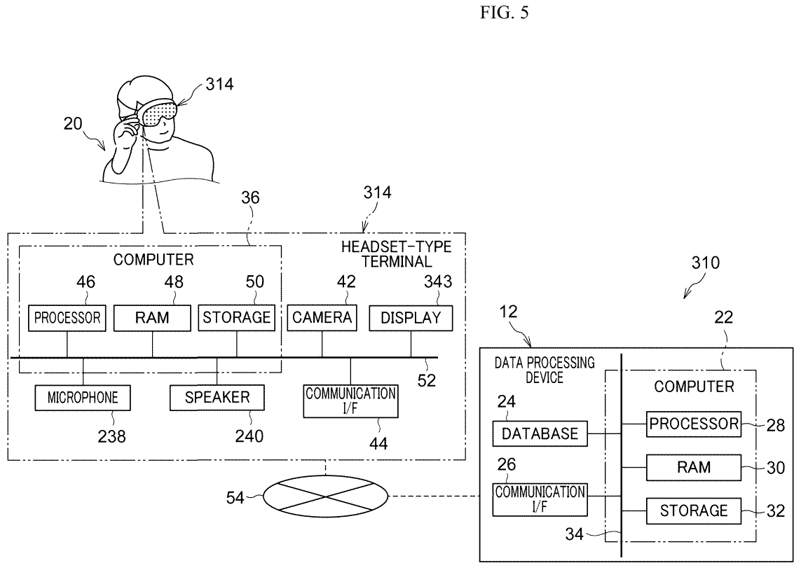

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

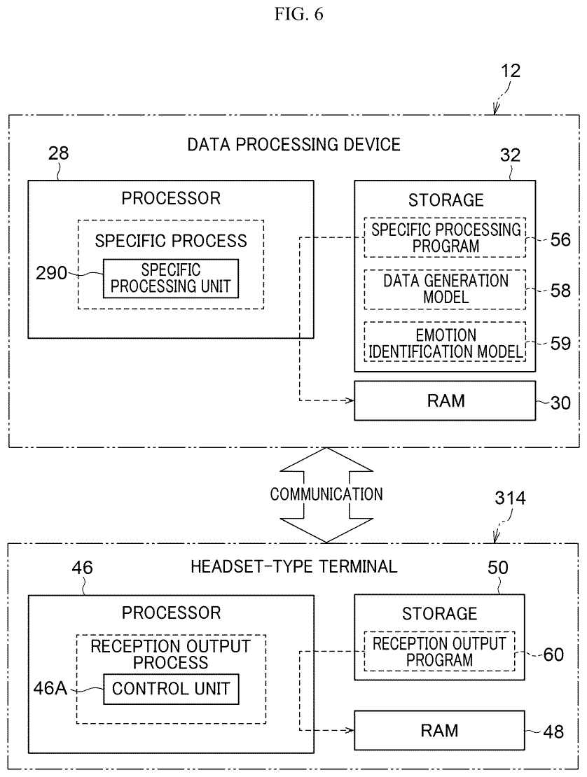

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

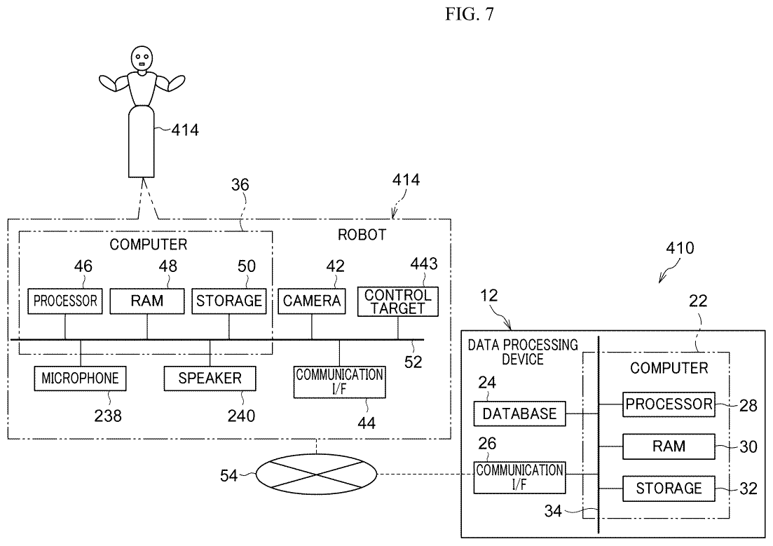

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

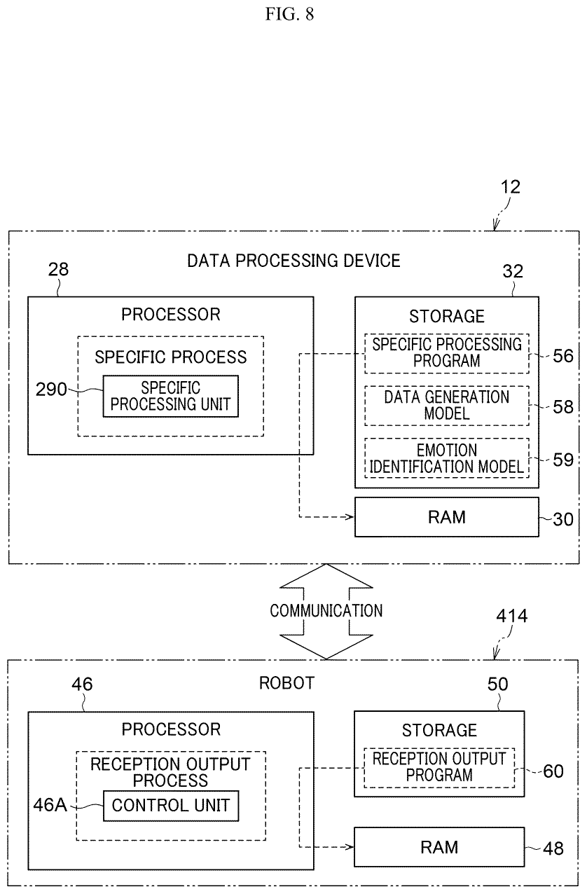

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

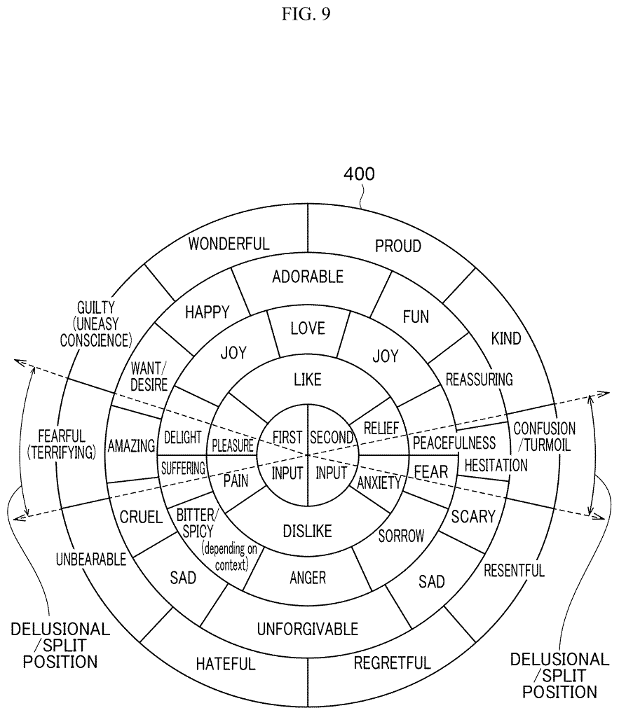

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

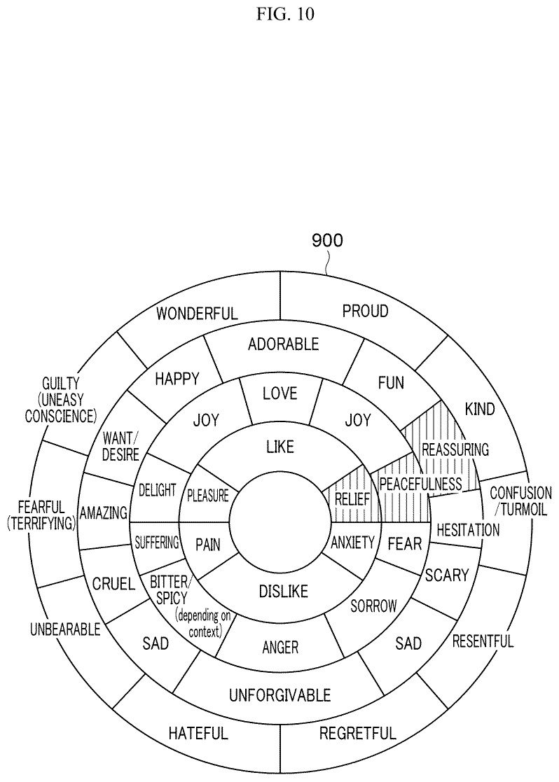

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a memory storing instructions,
wherein the processor is configured to
control a user interface to receive character information representing a user's experience and future goals, and to present an input area for user information input on a terminal, convert the received character information into a communication data format, validate a format of the communication data format, and transmit the communication data format via a communication protocol to an information processing apparatus,
analyze, in the information processing apparatus, the communication data format to obtain the character information, and execute natural language processing using a natural language processing algorithm to extract feature information including at least a job content, a skill, a desired field, and a target time from the character information,
generate, based on the feature information and the character information, a prompt sentence that specifies processing content and an output format to be executed by a generative AI model,
construct the prompt sentence as a communication request including authentication information, processing conditions, and the prompt sentence as response request data for a response generation function provided by an external generative AI model providing apparatus, and transmit the communication request via the communication protocol to the generative AI model providing apparatus,
receive, from the generative AI model providing apparatus, response data including response character information generated by the generative AI model based on the prompt sentence, analyze the response character information to extract constituent elements including at least a skill name, a learning item, a learning order, a recommended job, and an action candidate, and reconstruct the constituent elements as an advice information structure,
store the advice information structure in association with the prompt sentence as record information in the memory, and
generate, based on the advice information structure, visual output information including at least an advice display area in which a list of skills, a learning plan, recommended jobs, and action candidates regarding career development of the user are divided and displayed, and control display of the visual output information in association with the input area for user information input.

### (Supplementary 2)

The system according to supplementary 1, wherein the processor is configured to in the analysis of the character information, perform natural language processing including segmentation and part-of-speech tagging on the character information using the natural language processing algorithm, extract, from the character information, phrases indicating at least a role name, a field name, and an experience period, classify a state type of the user based on the extracted phrases, select a prompt sentence generation template corresponding to the classified state type, and generate the prompt sentence by inserting the feature information into the selected template so as to instruct the generative AI model regarding a processing policy and a response structure.

### (Supplementary 3)

The system according to supplementary 1, wherein the processor is configured to
perform content determination processing on the response character information received from the generative AI model, the content determination processing including at least determination of a length, an expression, and presence or absence of an inappropriate expression,
execute a filtering process to delete or convert a part of the response character information based on a result of the content determination processing, generate the advice information structure based on the filtered response character information, and
control the terminal to allocate each constituent element included in the advice information structure to a corresponding display area and visually present the constituent elements to the user.

### Application Example 1

### (Supplementary 1)

A system comprising a processor and a memory,
wherein the processor is configured to
provide, on a user terminal, an input interface that allows a user to input experience information and future objective information as character information, obtain, via the input interface, the experience information and the future objective information from the user, and transmit the obtained experience information and future objective information to an external information processing apparatus via a communication network,
store, in the memory, the experience information and the future objective information received from the external information processing apparatus, generate, on the basis of the experience information and the future objective information
stored in the memory, a prompt sentence for a generative information processing model, the prompt sentence including at least processing content to be executed by the generative information processing model and an output format of the generative information processing model,
transmit the prompt sentence to the generative information processing model and acquire, from the generative information processing model, generated content including information related to the experience information and the future objective information of the user, execute, on the generated content, a selection process and a formatting process including at least one of importance calculation, relevance determination, removal of unnecessary portions, and length adjustment, on the basis of preference information or attribute information stored in association with the user, so as to generate selected content adapted to the user,
convert the selected content into structured content in a data format including at least heading information, body information, and section information, and transmit the structured content to the user terminal via the communication network,
and control the user terminal so as to display the structured content on a display device of the user terminal as a visual representation including the heading information, the body information, and the section information,
and, in response to additional conditions or evaluation information input by the user via the user terminal, regenerate the prompt sentence and repeatedly execute transmission of the regenerated prompt sentence to the generative information processing model, acquisition of content from the generative information processing model, the selection process, the formatting process, and the display control.

### (Supplementary 2)

The system according to supplementary 1,
wherein the processor is configured to
perform a natural language processing operation on the experience information and the future objective information, the natural language processing operation including at least one of normalization of character types, syntactic analysis, extraction of important terms, and summarization, and
generate the prompt sentence including instruction information specifying at least a processing type to be executed by the generative information processing model, an amount of output, a structure of output, and an output language, on a basis of a result of the natural language processing operation.

### (Supplementary 3)

The system according to supplementary 1,
wherein the processor is configured to
divide the generated content acquired from the generative information processing model into a plurality of sections,
calculate, for each of the plurality of sections, an evaluation value on a basis of at least one of a phrase similarity between the section and the experience information and the future
objective information, a weight determined from the preference information of the user, and an information amount of the section,
rank the plurality of sections according to the evaluation values, and adopt, as the selected content, only sections whose ranks are equal to or higher than a predetermined rank among the plurality of sections.

### Example 2

### (Supplementary 1)

A system comprising a processor,
wherein the processor is configured to
provide, on an information input/output apparatus, an interface for accepting user experience information and future goal information of a user,
obtain the user experience information, the future goal information, and a prompt sentence input by the user, convert obtained natural language data into feature vectors by using natural language processing technology and embedding generation technology, generate user profile data based on the feature vectors, and store the user profile data in a storage device, obtain attribute information, work history information, and deliverable information of members belonging to an organization from a data storage device, convert obtained natural language data regarding the members into feature vectors by using natural language processing technology and embedding generation technology, generate member profile data, and store the member profile data in the storage device,
execute a machine learning model using the user profile data and the member profile data as input, identify members that conform to the user experience information and the future goal information, and generate a member recommendation list based on a degree of conformity,
generate prompt sentence data for inputting the prompt sentence to a generative artificial intelligence model, transmit the prompt sentence data to the generative artificial intelligence model and obtain response data, extract skill information, role information, and meeting condition information from the response data, and use the skill information, the role information, and the meeting condition information as conditions for member identification processing by the machine learning model and for scheduling processing,
generate meeting schedule information between the user and members selected by the user from candidates included in the member recommendation list via the information input/output apparatus, obtain availability information of participants through a communication interface of a schedule management system, calculate a common available time period based on the meeting condition information, and register the meeting schedule information in the schedule management system, and
perform display control to visually present the member recommendation list and the meeting schedule information on the information input/output apparatus.

### (Supplementary 2)

The system according to supplementary 1,
wherein the processor is configured to include, in the machine learning model, a neural network model or a regression model for calculating similarity between the user profile data and the member profile data and to generate the member recommendation list based on the similarity.

### (Supplementary 3)

The system according to supplementary 1,
wherein the processor is configured to generate explanation information describing reasons why respective members included in the member recommendation list are recommended, based on the response data from the generative artificial intelligence model, and to control display so as to present the explanation information together with the member recommendation list on the information input/output apparatus.

### Application Example 2

### (Supplementary 1)

A system comprising a processor,
wherein the processor is configured to provide a user interface that allows a user to input, in a natural language, information including at least user experience, future goals, and requests regarding schedules, through a user input/output unit,
perform information analysis processing on natural language input data acquired from the user input/output unit, the information analysis processing including language analysis processing and emotion analysis processing, acquire from a storage device attribute information of members belonging to an organization, operation status information of the members, and progress status information of tasks, and generate a prompt sentence that instructs a generative AI model to execute at least one of a person recommendation process, a task worker recommendation process, and a schedule setting process, on the basis of the user experience, the future goals, an emotion state of the user, the attribute information of the members, and the progress status information of the tasks, and transmit the prompt sentence to the generative AI model and obtain response information from the generative AI model, determine and recommend, as a person recommendation function, an appropriate member or an appropriate task worker to the user, on the basis of the response information obtained from the generative AI model and the attribute information of the members stored in the storage device,
acquire, as a schedule setting function, schedule information of the user and of the recommended member by utilizing a schedule management function, specify an optimal schedule time from free time periods of the user and the recommended member on the basis of the response information and the emotion state, and automatically register, at the optimal schedule time, a schedule between the user and the member, and
generate, as an advice information presenting function, advice information relating to at least one of career development, person selection, task assignment, and product selection for the user, on the basis of the response information, and visually present the advice information to the user through the user input/output unit.

### (Supplementary 2)

The system according to supplementary 1, wherein the processor is configured to construct, as an integrated inference function, an internal inference model that executes the person recommendation process or the task worker recommendation process by using, as learning data, the natural language input data, the attribute information of the members, and the progress status information of the tasks through a statistical information processing method or a machine learning method, and to determine a recommendation result by integrating an inference result of the internal inference model and the response information from the generative AI model.

### (Supplementary 3)

The system according to supplementary 1,
wherein the processor is configured to function as an emotion-adaptive schedule determination function that generates a prompt sentence instructing the generative AI model to evaluate candidate time periods, on the basis of schedule-related expressions extracted from the natural language input data, the emotion state specified by the emotion analysis processing, and a plurality of candidate time periods acquired from the schedule management function, and that selects a schedule time that reduces psychological load of the user, on the basis of an evaluation result obtained from the generative AI model.

What is claimed is:

1. A system comprising:
circuitry configured to:
receive, via a communication interface coupled to a packet-switched network, input data in text form from a terminal device;
perform natural language processing on the input data to extract feature information including a domain identifier, a skill descriptor, a target field, and a temporal parameter;
generate a prompt sentence based on the feature information, the prompt sentence instructing a generative neural network model to produce structured response data;
transmit the prompt sentence to the generative neural network model and acquire the structured response data from the generative neural network model;
parse the structured response data to extract constituent elements and organize the constituent elements into an output data structure; and
transmit the output data structure to the terminal device via the communication interface.

2. The system according to claim 1, wherein the natural language processing comprises tokenizing the input data into a sequence of tokens, performing part-of-speech tagging on the sequence of tokens, and performing named entity recognition to identify the domain identifier and the skill descriptor.

3. The system according to claim 2, wherein the circuitry is further configured to compute feature vectors from the sequence of tokens using a text embedding model, and use the feature vectors to construct the prompt sentence by inserting the feature information into a prompt template stored in a storage device.

4. The system according to claim 3, wherein the prompt template specifies an output format for the structured response data, and wherein the circuitry sets inference parameters including a temperature value and a maximum output length before transmitting the prompt sentence to the generative neural network model.

5. The system according to claim 4, wherein the input data comprises a first text segment describing past experience of a user of the terminal device and a second text segment describing a future goal of the user, and wherein the feature information extracted from the first text segment includes a job content descriptor and a skill descriptor, and the feature information extracted from the second text segment includes the target field and the temporal parameter.

6. The system according to claim 1, wherein the constituent elements comprise a plurality of categorized data segments, each categorized data segment being associated with a category label extracted from the structured response data.

7. The system according to claim 6, wherein the circuitry is further configured to generate visual output information from the output data structure, the visual output information comprising a plurality of display areas each corresponding to one of the categorized data segments, and transmit the visual output information to the terminal device for rendering.

8. The system according to claim 7, wherein the categorized data segments include at least a skill list segment, a learning plan segment with a learning order, an action candidate segment, and a recommended role segment relating to career development of a user of the terminal device.

9. The system according to claim 1, wherein the circuitry is further configured to retrieve, from a storage device, attribute information of a plurality of entities associated with an organization identifier, and incorporate the attribute information into the prompt sentence as supplementary context for the generative neural network model.

10. The system according to claim 9, wherein the circuitry is further configured to perform emotion analysis on the input data using an emotion identification model to determine an emotion state of a user of the terminal device, and incorporate the emotion state into the prompt sentence.

11. The system according to claim 10, wherein the circuitry is further configured to adjust a ranking or presentation priority of the constituent elements in the output data structure based on the emotion state.

12. The system according to claim 1, wherein the structured response data includes a person recommendation, and wherein the circuitry is further configured to match the person recommendation against attribute information of members stored in a storage device to identify a recommended member, and include an identifier of the recommended member in the output data structure.

13. The system according to claim 12, wherein the circuitry is further configured to retrieve schedule information of the user of the terminal device and of the recommended member from a schedule management storage device, identify an available time period common to both, and register a schedule entry at the available time period.

14. The system according to claim 1, wherein the generative neural network model comprises a transformer-based language model, and wherein the structured response data is generated by the transformer-based language model performing inference on token sequences derived from the prompt sentence.

15. The system according to claim 14, wherein the circuitry is further configured to validate the structured response data by checking that each constituent element conforms to a predefined schema before organizing the constituent elements into the output data structure.

16. The system according to claim 1, wherein the circuitry is further configured to store the prompt sentence and the corresponding output data structure in a log repository in association with a user identifier, and use the stored prompt sentences and output data structures to refine subsequent prompt generation.

17. The system according to claim 16, wherein the circuitry is further configured to receive feedback data from the terminal device indicating a user evaluation of the output data structure, and update weighting parameters used in constructing the prompt sentence based on the feedback data.

18. A system comprising:
circuitry configured to:
receive, via a communication interface coupled to a packet-switched network, input data in text form from a terminal device, the input data comprising a first text segment describing past experience and a second text segment describing a future goal;
perform natural language processing on the input data to tokenize the input data and extract feature information including a domain identifier, a skill descriptor, a target field, and a temporal parameter;
construct a prompt sentence by inserting the feature information into a prompt template specifying an output format, the prompt sentence instructing a transformer-based generative neural network model to produce structured response data;
transmit the prompt sentence to the transformer-based generative neural network model and acquire the structured response data;
parse the structured response data to extract constituent elements including a skill list, a learning plan with a learning order, and an action candidate list;
organize the constituent elements into an output data structure comprising a plurality of categorized data segments; and
transmit visual output information derived from the output data structure to the terminal device via the communication interface, the visual output information comprising a plurality of display areas each corresponding to one of the categorized data segments.

19. The system according to claim 18, wherein the circuitry is further configured to perform emotion analysis on the input data to determine an emotion state, retrieve attribute information of members associated with an organization from a storage device, and generate, based on the structured response data and the emotion state, a person recommendation identifying a member whose attribute information matches requirements derived from the feature information.

20. A method performed by circuitry of a server coupled to a packet-switched network via a communication interface, the method comprising:
receiving, via the communication interface, input data in text form from a terminal device;
performing natural language processing on the input data to extract feature information including a domain identifier, a skill descriptor, a target field, and a temporal parameter;
generating a prompt sentence based on the feature information, the prompt sentence instructing a generative neural network model to produce structured response data;
transmitting the prompt sentence to the generative neural network model and acquiring the structured response data from the generative neural network model;
parsing the structured response data to extract constituent elements and organizing the constituent elements into an output data structure; and
transmitting the output data structure to the terminal device via the communication interface.
